(19) United States
(12) Patent Application Publication
(10) Pub. No.: US 2016/0006864 A1
(43) Pub. Date: Jan. 7, 2016

(54) MOBILE TERMINAL AND CONTROL METHOD THEREOF

(71) Applicant: LG ELECTRONICS INC., Yeongdeungpo-gu, Seoul (KR)

(72) Inventors: Hyuntaek PARK, Seoul (KR); Jinah KANG, Seoul (KR); Bongseok CHOI, Seoul (KR)

(21) Appl. No.: 14/771,610

(22) PCT Filed: Mar. 7, 2014
(86) PCT No.: PCT/KR2014/001917

§ 371 Date: Aug. 31, 2015

Related U.S. Application Data
(60) Provisional application No. 61/775,137, filed on Mar. 8, 2013.

(30) Foreign Application Priority Data
Sep. 27, 2013 (KR) 10-2013-0115556
Nov. 5, 2013 (KR) 10-2013-0133741

(51) Int. Cl. H04M 1/725; G06F 3/0484; G06F 3/0488; G06F 3/0481

(52) U.S. Cl. CPC H04M 1/72583; H04M 1/7253; G06F 3/04817; G06F 3/04842; G06F 3/0488

(57) ABSTRACT

The present disclosure relates to a mobile terminal capable of performing bidirectional communication with an image display device, and a control method thereof. A mobile terminal according to one exemplary embodiment includes a wireless communication unit that is configured to perform bidirectional communication with an image display device and perform pairing with the image display device, a display unit that is configured to display a content thereon, and a controller that is configured to execute an application in response to a preset touch input being sensed on the content, and transmit a uniform resource locator (URL) corresponding to the content to the image display device, such that the content can be output on the image display device, when a preset icon is selected from icons displayed on an execution screen of the application.

### TECHNICAL FIELD

The present disclosure relates to a mobile terminal, and more particularly, a mobile terminal capable of performing bidirectional communication with an image display device, and a control method thereof.

### BACKGROUND ART

Terminals may be divided into mobile/portable terminals and stationary terminals according to their mobility. Also, the mobile terminals may be classified into handheld terminals and vehicle mount terminals according to whether or not a user can directly carry.

As it becomes multifunctional, a mobile terminal can be allowed to capture still images or moving images, play music or video files, play games, receive broadcast and the like, so as to be implemented as an integrated multimedia player. Efforts are ongoing to support and increase the functionality of mobile terminals. Such efforts include software and hardware improvements.

With the improvements, the terminal may display contents on a display unit. However, a user suffers from viewing the contents on a small screen due to the size limitation of the display unit.

In addition, an image display device may also display contents on a display unit. However, a user suffers from searching for a content to be output on the image display device due to an inconvenient manipulation of a remote controller. The user also feels inconvenient in controlling the image display device due to a limited manipulation of the remote controller.

### DISCLOSURE OF INVENTION

### Technical Problem

Therefore, to obviate those problems, an aspect of the detailed description is to provide a mobile terminal capable of improving user convenience in outputting contents on an image display device, and a control method thereof.

Another aspect of the present disclosure is to provide a mobile terminal capable of improving user convenience in controlling an image display device, and a control method thereof.

### Solution to Problem

To achieve these and other advantages and in accordance with the purpose of the present invention, as embodied and broadly described herein, there is provided a mobile terminal including, a wireless communication unit that is configured to perform bidirectional communication with an image display device, and perform pairing with the image display device, a display unit that is configured to display a content thereon, and a controller that is configured to execute an application when a preset touch input is sensed on the content, and transmit a uniform resource locator, corresponding to the content, to the image display device, such that the content can be output on the image display device, when a preset icon is selected from icons displayed on an execution screen of the application.

In accordance with an exemplary embodiment, the controller may display a list of image display devices including items, corresponding to a plurality of applications, respectively, belonging to the same network as the mobile terminal, when the application is executed, and the wireless communication unit may performing pairing with an image display device corresponding to at least one item selected when the at least one item is selected from the items corresponding to the plurality of image display devices.

In accordance with an exemplary embodiment, the controller may display a popup window for receiving an authentication code, entered in relation to the image display device, and perform the pairing with the image display device when the authentication code related to the image display device is entered onto the popup window.

In accordance with an exemplary embodiment, the controller may display information related to the paired image display device on the execution screen of the application.

In accordance with an exemplary embodiment, the controller may display a list of applications including items, corresponding to a plurality of applications, respectively, related to a content, when a preset touch input is sensed on the content, and execute an application corresponding to the selected item from the list of applications.

In accordance with an exemplary embodiment, the list of applications may include an item of an application corresponding to a function of outputting the content on the image display device.

In accordance with an exemplary embodiment, the controller may display information related to the content on the execution screen of the application.

In accordance with an exemplary embodiment, the information related to the content may include at least one of a name, a capacity and a file attribute of the content.

In accordance with an exemplary embodiment, the execution of the application may include a first icon corresponding to a function of outputting the content directly to the image display device. The controller may transmit a URL corresponding to the content to the image display device, together with a control command to output the content directly to the image display device when the first icon is selected.

In accordance with an exemplary embodiment, the execution screen of the application may include a second icon corresponding to a function of adding the content to a reproduction list of the image display device. The controller may transmit a URL corresponding to the content to the image display device, together with a control command to output the content to the image display device after stopping an output of a currently-output another content, when the second icon is selected.

In accordance with an exemplary embodiment, the execution screen of the application may include a third icon corresponding to a function of adding the content to a reproduction list of the mobile terminal. The controller may add the content to the reproduction list of the mobile terminal when the third icon is selected.

In accordance with an exemplary embodiment, the execution screen of the application may include a fourth icon corresponding to a function of displaying a reproduction list of the mobile terminal, including the content. The controller may display the reproduction list including items corresponding pre-added contents when the fourth icon is selected.

In accordance with an exemplary embodiment, the controller may edit the reproduction list based on a touch input sensed on the reproduction list.

In accordance with an exemplary embodiment, the controller may transmit a URL of a content corresponding to an item selected from the reproduction list to the image display device.

In accordance with another exemplary embodiment of the present disclosure, there is provided a mobile terminal including a wireless communication unit that is configured to perform bidirectional communication with an image display device, perform pairing with the image display device, and receive a message from the image display device via a server, a display unit that is configured to be touch-sensitive for allowing an input of a message to be transmitted to the image display device, and display both the received message and the input message, and a controller that is configured to transmit the input message to the image display device via the server such that the image display device can be controlled according to a control command included in the input message.

In accordance with the exemplary embodiment, the controller may display a popup window for receiving an authentication code, entered in relation to the image display device. The controller may transmit a message including the entered authentication code to the image display device via the server when the authentication code related to the image display device is entered onto the pop-up window.

In accordance with the exemplary embodiment, the controller may display the received message on an execution screen of a messenger application while the messenger application is executed on a foreground.

In accordance with the exemplary embodiment, the controller may receive a message, which is input in response to the received message, on the execution screen of the messenger application, and transmit the input message to the image display device via the server.

In accordance with the exemplary embodiment, the controller may transmit a message including a URL corresponding to a content to the image display device via the server such that the image display device can be controlled in relation to the content.

In accordance with the exemplary embodiment, the controller may display a list of applications including items, which correspond to a plurality of applications, respectively, related to the content, when a preset touch input is sensed on the content while the content is displayed. The controller may transmit a message including the URL corresponding to the content to the image display device via the server when a preset item is selected from the list of applications.

In accordance with the exemplary embodiment, the message received from the image display device may include a function for selecting one of a function of outputting the content directly to the image display device and a function of adding the content to the reproduction list of the image display device.

In accordance with the exemplary embodiment, the message received from the image display device may include a plurality of channel information outputtable by the image display device.

In accordance with the exemplary embodiment, the message received from the image display device may include content recommendation information based on user's use pattern information among contents outputtable by the image display device.

In accordance with the exemplary embodiment, the message received from the image display device may include an advertisement content based on the user's use pattern information.

In accordance with the exemplary embodiment, the message received from the image display device may include information related to a content which is currently output on the image display device.

In accordance with the exemplary embodiment, the controller may cooperate the received information with an application stored in the mobile terminal when the information related to the content is received.

In accordance with the exemplary embodiment, the display unit may display at least one virtual button for controlling a function of the image display device. The controller may transmit a message including a control command, corresponding to a touched virtual button, to the image display device via the server, such that the image display device can be controlled according to the control command corresponding to the touched virtual button when a touch input is sensed on the virtual button.

In accordance with the exemplary embodiment, the display unit may display a plurality of pre-transmitted messages. The controller may retransmit one selected message to the image display device via the server when the one message is selected from the pre-transmitted messages.

### Advantageous Effects of Invention

In accordance with the detailed description, an image display device may receive a

URL corresponding to a content from a mobile terminal. That is, the image display device may receive a URL with a much smaller capacity than the content itself from the mobile terminal. This may allow for efficient use of a battery resource and a data resource of the mobile terminal.

In accordance with the detailed description, the image display device may output the content using the URL of the content, received from the mobile terminal. Accordingly, the user may easily search for a content using a touch screen of the mobile terminal, and view the searched content through a display unit of the mobile terminal. Consequently, the user's convenience can be enhanced.

In accordance with the detailed description, the mobile terminal may receive information related to a content, which is currently played on the image display device, from the image display device via a server. This may facilitate the user to acquire the information related to the content in the form of message.

In accordance with the detailed description, the mobile terminal may transmit a control command to control the image display device to the image display device via the server. This may facilitate the user to control the image display device simply using the touch screen of the mobile terminal, without use of a remote controller. Consequently, the user's convenience can be enhanced.

### BRIEF DESCRIPTION OF DRAWINGS

FIG. 1 is a block diagram of a mobile terminal in accordance with one exemplary embodiment of the present disclosure;

FIG. 2A is a front perspective view of one example of a mobile terminal in accordance with the present disclosure;

FIG. 2B is a rear perspective view of the mobile terminal illustrated in FIG. 2A;

FIG. 3 is a conceptual view of a system including an image display device in accordance with the present disclosure;

FIG. 4 is a block diagram of an image display device and an external input device in accordance with the present disclosure;

FIG. 5 is a flowchart for describing one exemplary embodiment of a mobile terminal in accordance with the present disclosure;

FIGS. 6 to 8 are conceptual views illustrating an exemplary embodiment in which the mobile terminal and the image display device are paired with each other;

FIGS. 9 to 11 are conceptual views illustrating an exemplary embodiment of selecting a content to be output on the image display device;

FIGS. 12 and 13 are conceptual views illustrating an exemplary embodiment of outputting the content directly to the image display device;

FIGS. 14 and 15 are conceptual views illustrating an exemplary embodiment of adding a content to a reproduction list of the image display device;

FIG. 16 is a conceptual view illustrating an exemplary embodiment of adding a content to a reproduction list of the mobile terminal;

FIGS. 17 to 19 are conceptual views illustrating an exemplary embodiment of displaying the reproduction list of the mobile terminal;

FIGS. 20 and 21 are conceptual views illustrating an exemplary embodiment of outputting a content on an image display device;

FIG. 22 is a flowchart illustrating another exemplary embodiment of a mobile terminal in accordance with the present disclosure;

FIGS. 23 to 25 are conceptual views illustrating an exemplary embodiment in which the mobile terminal and the image display device are paired with each other;

FIGS. 26 and 27 are conceptual views illustrating an exemplary embodiment of transmitting and receiving messages to and from the image display device;

FIGS. 28 to 31 are conceptual views illustrating an exemplary embodiment of outputting contents directly on the image display device; and

FIGS. 32 to 39 are conceptual views illustrating an exemplary embodiment of transmitting a receiving message related to a control of the image display device.

### MODE FOR THE INVENTION

Description will now be given in detail according to the exemplary embodiments disclosed herein, with reference to the accompanying drawings. For the sake of brief description with reference to the drawings, the same or equivalent components will be provided with the same reference numbers, and description thereof will not be repeated. A suffix “module” and “unit” used for constituent elements disclosed in the following description is merely intended for easy description of the specification, and the suffix itself does not give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings.

Mobile terminals described herein may include cellular phones, smart phones, laptop computers, digital broadcasting terminals, personal digital assistants (PDAs), portable multimedia players (PMPs), navigators, slate PCs, tablet PCs, ultra books, and the like. However, it may be easily understood by those skilled in the art that the configuration according to the exemplary embodiments of this specification can also be applied to stationary terminals such as digital TV, desktop computers and the like, excluding a case of being applicable only to the mobile terminals.

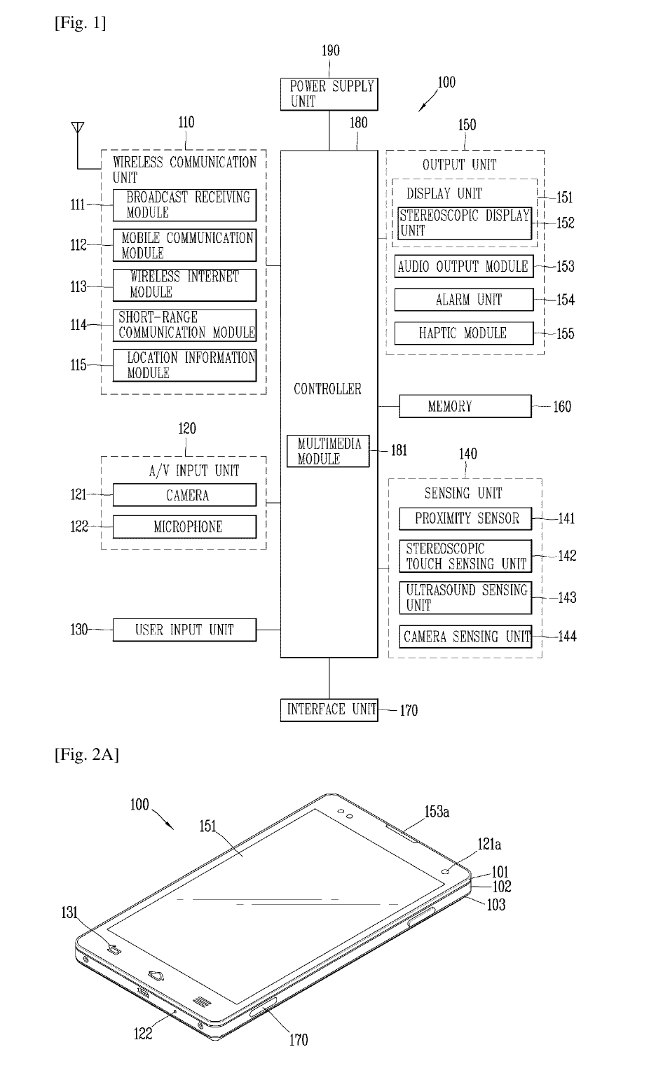

FIG. 1A is a block diagram of a mobile terminal in accordance with the present disclosure.

The mobile terminal 100 may include components, such as a wireless communication unit 110, an input unit 120, a sensing unit 140, an output unit 150, an interface unit 160, a memory 170, a controller 180, a power supply unit 190 and the like. FIG. 1A illustrates the mobile terminal having various components, but it may be understood that implementing all of the illustrated components is not a requirement. Greater or fewer components may alternatively be implemented.

Hereinafter, each component will be described in sequence.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 may receive a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of the broadcast associated information may include information associated with a broadcast channel, a broadcast program, a broadcast service provider, or the like. The broadcast associated information may also be provided via a mobile communication network, and, in this case, received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111, for example, may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 may transmit/receive wireless signals to/from at least one of network entities, for example, abase station, an external mobile terminal, a server, and the like, on a mobile communication network. Here, the wireless signals may include audio call signal, video (telephony) call signal, or various formats of data according to transmission/reception of text/multimedia messages.

The mobile communication module 112 may implement a video (telephony) call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 denotes a module for wireless Internet access. This module may be internally or externally coupled to the mobile terminal 100. Examples of such wireless Internet access may include Wireless LAN (WLAN), Wireless Fidelity (Wi-Fi) Direct, Digital Living Network Alliance (DLNA), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee, Near Field Communication (NFC) and the like.

The location information module 115 denotes a module for detecting or calculating a position of the mobile terminal. An example of the location information module 115 may include a Global Position System (GPS) module or a WiFi module.

Still referring to FIG. 1, the A/V input unit 120 may be configured to provide an audio or video signal input to the mobile terminal. The A/V input unit 120 may include a camera 121 and a microphone 122. The camera 121 may receive and process image frames of still pictures or video obtained by image sensors in a video call mode or a capture mode. The processed image frames may be displayed on a display unit 151.

The image frames processed by the camera 121 may be stored in the memory 160 or transmitted to an external device via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal may then be processed into digital data. The processed digital data may be converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate data input by a user to control the operation of the mobile terminal. The user input unit 130 may include a keypad, a dome switch, a touchpad (e.g., static pressure/capacitance), a jog wheel, a jog switch and the like.

The sensing unit 140 may provide status measurements of various aspects of the mobile terminal. For instance, the sensing unit 140 may detect an open/close status of the mobile terminal 100, a location of the mobile terminal 100, a presence or absence of user contact with the mobile terminal 100, an orientation of the mobile terminal 100, acceleration/deceleration of the mobile terminal 100, and the like, so as to generate a sensing signal for controlling the operation of the mobile terminal 100. For example, regarding a slide phone type mobile terminal, the sensing unit 140 may sense whether the slide phone type mobile terminal is open or closed. Other examples may include sensing statuses, the presence or absence of power provided by the power supply 190, the presence or absence of a coupling or other connection between the interface unit 170 and an external device, and the like.

The output unit 150 may be configured to output an audio signal, a video signal or a tactile signal. The output unit 150 may include a display unit 151, an audio output module 153, an alarm unit 154, a haptic module 155 and the like.

The display unit 151 may output information processed in the mobile terminal 100. For example, when the mobile terminal is operating in a phone call mode, the display unit 151 may provide a User Interface (UI) or a Graphic User Interface (GUI), which includes information associated with the call. As another example, if the mobile terminal is in a video call mode or a capture mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display and the like.

Some of such displays may be implemented as a transparent type or an optical transparent type through which the exterior is visible, which is referred to as a transparent display. A representative example of the transparent display may include a Transparent OLED (TOLED), or the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the display units 151 may be arranged on one surface to be spaced apart from or integrated with each other, or may be arranged on different surfaces.

The display unit 151 may also be implemented as a stereoscopic display unit 152 for displaying stereoscopic images.

Here, the stereoscopic image may be a three-dimensional (3D) stereoscopic image. The 3D stereoscopic image refers to an image making a viewer feel that a gradual depth and reality of an object on a monitor or a screen is the same as a realistic space. The 3D stereoscopic image may be implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, may include Wheatstone stereoscopic scheme, or the like.

The auto-stereoscopic scheme may include, for example, a parallax barrier scheme, a lenticular scheme, an integral imaging scheme, a switchable lens, or the like. The projection scheme may include a reflective holographic scheme, a transmissive holographic scheme, and the like.

In general, a 3D stereoscopic image may be comprised of a left image (a left eye image) and a right image (a right eye image). According to how left and right images are combined into a 3D stereoscopic image, a 3D stereoscopic imaging method may be divided into a top-down method in which left and right images are disposed up and down in a frame, an L-to-R (left-to-right or side by side) method in which left and right images are disposed left and right in a frame, a checker board method in which fragments of left and right images are disposed in a tile form, an interlaced method in which left and right images are alternately disposed by columns or rows, and a time sequential (or frame by frame) method in which left and right images are alternately displayed on a time basis.

Also, as for a 3D thumbnail image, a left image thumbnail and a right image thumbnail may be generated from a left image and a right image of an original image frame, respectively, and then combined to generate a single 3D thumbnail image. In general, thumbnail refers to a reduced image or a reduced still image. The thusly generated left image thumbnail and the right image thumbnail may be displayed with a horizontal distance difference therebetween by a depth corresponding to the disparity between the left image and the right image on the screen, providing a stereoscopic space sense.

A left image and a right image required for implementing a 3D stereoscopic image may be displayed on the stereoscopic display unit 152 by a stereoscopic processing unit (not shown). The stereoscopic processing unit may receive the 3D image and extract the left image and the right image, or may receive the 2D image and change it into a left image and a right image.

Here, if the display unit 151 and a touch sensitive sensor (referred to as a ‘touch sensor’) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals may be transmitted to a touch controller. The touch controller may process the received signals, and then transmit corresponding data to the controller 180. Accordingly, the controller 180 may sense which region of the display unit 151 has been touched.

Still referring to FIG. 1, a proximity sensor 141 may be arranged at an inner region of the mobile terminal covered by the touch screen, or near the touch screen. The proximity sensor 141 may be provided as one example of the sensing unit 140. The proximity sensor 141 refers to a sensor to sense presence or absence of an object approaching to a surface to be sensed, or an object disposed near a surface to be sensed, by using an electromagnetic field or infrared rays without a mechanical contact. The proximity sensor 141 may have a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen may be sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position will correspond to a position where the pointer faces perpendicular to the touch screen upon the proximity touch of the pointer.

The proximity sensor 141 may sense proximity touch, and proximity touch patterns (e.g., distance, direction, speed, time, position, moving status, etc.). Information relating to the sensed proximity touch and the sensed proximity touch patterns may be output onto the touch screen.

When a touch sensor is overlaid on the stereoscopic display unit 152 in a layered manner (hereinafter, referred to as a ‘stereoscopic touch screen’), or when the stereoscopic display unit 152 and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144.

The proximity sensor 141 may detect the distance between a sensing object (for example, the user's finger or a stylus pen), applying a touch by using the force of electromagnetism or infrared rays without a mechanical contact, and a detect surface. By using the distance, the terminal may recognize which portion of a stereoscopic image has been touched. In particular, when the touch screen is an electrostatic touch screen, the degree of proximity of the sensing object may be detected based on a change of an electric field according to proximity of the sensing object, and a touch to the 3D image may be recognized by using the degree of proximity.

The stereoscopic touch sensing unit 142 may be configured to detect the strength or duration of a touch applied to the touch screen. For example, the stereoscopic touch sensing unit 142 may sense touch pressure. When the pressure is strong, it may recognize the touch as a touch with respect to an object located farther away from the touch screen toward the inside of the terminal.

The ultrasonic sensing unit 143 may be configured to recognize position information relating to the sensing object by using ultrasonic waves.

The ultrasonic sensing unit 143 may include, for example, an optical sensor and a plurality of ultrasonic sensors. The optical sensor may be configured to sense light and the ultrasonic sensors may be configured to sense ultrasonic waves. Since light is much faster than ultrasonic waves, a time for which the light reaches the optical sensor may be much shorter than a time for which the ultrasonic wave reaches the ultrasonic sensor. Therefore, a position of a wave generation source may be calculated by using a time difference from the time that the ultrasonic wave reaches based on the light as a reference signal.

The camera sensing unit 144 may include at least one of the camera 121, a photo sensor, and a laser sensor.

For example, the camera 121 and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor may be configured to scan a movement of the sensing object in proximity to the touch screen. In more detail, the photo sensor may include photo diodes and transistors at rows and columns to scan content mounted on the photo sensor by using an electrical signal changing according to the quantity of applied light. Namely, the photo sensor may calculate the coordinates of the sensing object according to variation of light to thus obtain position information of the sensing object.

The audio output module 153 may output audio data received from the wireless communication unit 110 or stored in the memory 160 in a call signal reception mode, a call mode, a record mode, a voice recognition mode, a broadcast reception mode, and the like. Also, the audio output module 153 may provide audible output signals related to a particular function (e.g., a call signal reception sound, a message reception sound, etc.) performed by the mobile terminal 100. The audio output module 153 may include a receiver, a speaker, a buzzer or the like.

The alarm unit 154 may output a signal for informing about an occurrence of an event of the mobile terminal 100. Events generated in the mobile terminal, for example, may include call signal reception, message reception, key signal inputs, a touch input, etc. In addition to video or audio signals, the alarm unit 154 may output signals in a different manner, for example, using vibration to inform of an occurrence of an event. The video or audio signals may also be output via the display unit 151 and the audio output module 153. Hence, the display unit 151 and the audio output module 153 may be classified as parts of the alarm unit 154.

A haptic module 155 may generate various tactile effects the that user may feel. A typical example of the tactile effect generated by the haptic module 155 is vibration. Strength, pattern and the like of the vibration generated by the haptic module 155 may be controllable by a user selection or setting of the controller. For example, different vibrations may be combined to be outputted or sequentially outputted.

Besides vibration, the haptic module 155 may generate various other tactile effects, including an effect by stimulation such as a pin arrangement vertically moving with respect to a contact skin, a spray force or suction force of air through a jet orifice or a suction opening, a touch on the skin, a contact of an electrode, electrostatic force, etc., an effect by reproducing the sense of cold and warmth using an element that can absorb or generate heat, and the like.

The haptic module 155 may be implemented to allow the user to feel a tactile effect through a muscle sensation such as the user's fingers or arm, as well as transferring the tactile effect through a direct contact. Two or more haptic modules 155 may be provided according to the configuration of the mobile terminal 100.

The memory 160 may store programs used for operations performed by the controller, or may temporarily store input and/or output data (for example, a phonebook, messages, still images, video, etc.). In addition, the memory 160 may store data regarding various patterns of vibrations and audio signals output when a touch input is sensed on the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 may serve as an interface with every external device connected with the mobile terminal 100. For example, the interface unit 170 may receive data transmitted from an external device, receive power to transfer to each element within the mobile terminal 100, or transmit internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 170.

When the mobile terminal 100 is connected with an external cradle, the interface unit 170 may serve as a passage to allow power from the cradle to be supplied to the mobile terminal 100 therethrough or may serve as a passage to allow various command signals input by the user from the cradle to be transferred to the mobile terminal therethrough. Various command signals or power input from the cradle may operate as signals for recognizing that the mobile terminal is properly mounted on the cradle.

The controller 180 may typically control the general operations of the mobile terminal 100. For example, the controller 180 may perform controlling and processing associated with voice calls, data communications, video calls, and the like. The controller 180 may include a multimedia module 181 for playbacking multimedia data. The multimedia module 181 may be configured within the controller 180 or may be configured to be separated from the controller 180.

The controller 180 may perform pattern recognition processing to recognize a handwriting input or a picture drawing input performed on the touch screen as characters or images, respectively.

Also, the controller 180 may execute a lock state to restrict a user from inputting control commands for applications when a state of the mobile terminal meets a preset condition. Also, the controller 180 may control a lock screen displayed in the lock state based on a touch input sensed on the display unit 151 in the lock state of the mobile terminal.

The power supply unit 190 may receive external power or internal power and supply appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, description will be given of a structure of the mobile terminal according to an embodiment of the present disclosure as illustrated in FIG. 1.

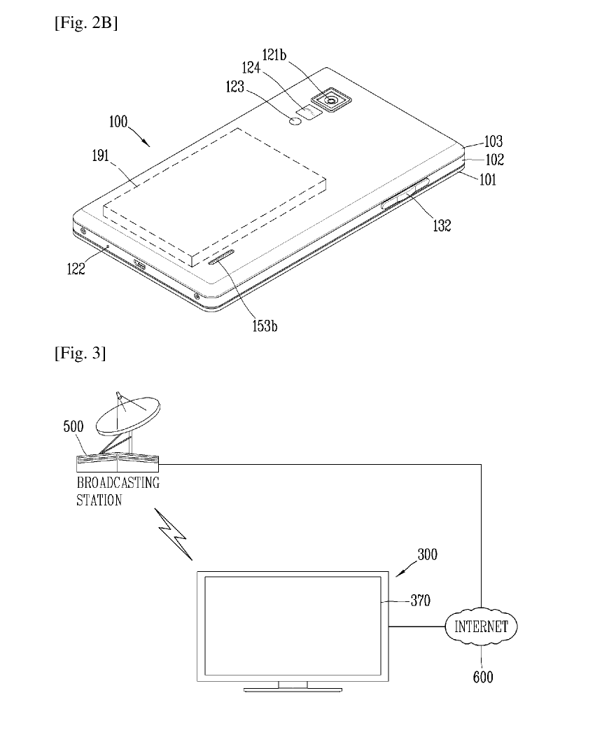

FIG. 2A is a front perspective view illustrating an example of a mobile terminal 100 associated with the present disclosure.

The mobile terminal 100 disclosed herein may be provided with a bar-type terminal body. However, the present disclosure may not be limited to this, but also may be applicable to various structures such as watch type, clip type, glasses type or folder type, flip type, slide type, swing type, swivel type, or the like, in which two and more bodies are combined with each other in a relatively movable manner.

The body may include a case (casing, housing, cover, etc.) forming the appearance of the terminal. In this embodiment, the case may be divided into a front case 101 and a rear case 102. Various electronic components may be incorporated into a space formed between the front case 101 and the rear case 102. At least one middle case may be additionally disposed between the front case 101 and the rear case 102, and a battery cover 103 for covering a battery 191 may be detachably configured at the rear case 102.

The cases may be formed by injection-molding synthetic resin or may be formed of a metal, for example, stainless steel (STS), titanium (Ti), or the like.

A display unit 151, a first audio output module 153a, a first camera 121a, a first manipulating unit 131 and the like may be disposed on a front surface of the terminal body, and a microphone 122, an interface unit 170, a second manipulating unit 132 and the like may be provided on a lateral surface thereof.

The display unit 151 may be configured to display (output) information being processed in the mobile terminal 100. The display unit 151 may visually output information by including at least one of a liquid crystal display (LCD), a thin film transistor-liquid crystal display (TFT-LCD), an organic light emitting diode (OLED), a flexible display, a 3-dimensional (3D) display, and an e-ink display.

The display unit 151 may include a touch sensing element to receive a control command by a touch method. When a touch is made to any one place on the display unit 151, the touch sensing element may be configured to sense this touch and enter the content corresponding to the touched place. The content entered by a touch method may be a text or numerical value, or a menu item which can be indicated or designated in various modes.

The touch sensing element may be formed with transparency to allow visual information displayed on the display unit 151 to be seen, and may include a structure for enhancing visibility of a touch screen at bright places. Referring to FIG. 3A, the display unit 151 occupies a most portion of the front surface of the front case 101.

The first audio output unit 153a and the first camera 121a may be disposed in a region adjacent to one of both ends of the display unit 151, and the first manipulation input unit 131 and the microphone 122 may be disposed in a region adjacent to the other end thereof. The second manipulation interface 132 (refer to FIG. 3B), the interface 170, and the like may be disposed on a lateral surface of the terminal body.

The first audio output module 153a may be implemented in the form of a receiver for transferring voice sounds to the user's ear or a loud speaker for outputting various alarm sounds or multimedia reproduction sounds.

It may be configured such that the sounds generated from the first audio output module 153a are released along an assembly gap between the structural bodies. In this case, a hole independently formed to output audio sounds may not be seen or hidden in terms of appearance, thereby further simplifying the appearance of the mobile terminal 100. However, the present disclosure may not be limited to this, but a hole for releasing the sounds may be formed on a window.

The first camera 121a may process video frames such as still or moving images obtained by the image sensor in a video call mode or a capture mode. The processed video frames may be displayed on the display unit 151.

The user input unit 130 may be manipulated by a user to input a command for controlling the operation of the mobile terminal 100. The user input unit 130 may include first and second manipulation units 131 and 132. The first and the second manipulation units 131 and 132 may be commonly referred to as a manipulating portion, and any method may be employed if it is a tactile manner allowing the user to perform manipulation with a tactile feeling such as touch, push, scroll or the like.

In the drawing, it is illustrated on the basis that the first manipulation unit 131 is a touch key, but the present disclosure may not be necessarily limited to this. For example, the first manipulation unit 131 may be configured with a mechanical key, or a combination of a touch key and a push key.

The content received by the first and/or second manipulation units 131 and 132 may be set in various ways. For example, the first manipulation unit 131 may be used by the user to input a command such as menu, home key, cancel, search, or the like, and the second manipulation unit 132 may be used by the user to input a command, such as controlling a volume level being output from the first audio output module 153a, switching into a touch recognition mode of the display unit 151, or the like.

The microphone 122 may be formed to receive the user's voice, other sounds, and the like. The microphone 122 may be provided at a plurality of places, and configured to receive stereo sounds.

The interface unit 170 may serve as a path allowing the mobile terminal 100 to exchange data with external devices. For example, the interface unit 170 may be at least one of a connection terminal for connecting to an earphone in a wired or wireless manner, a port for near field communication (for example, an Infrared Data Association (IrDA) port, a Bluetooth port, a wireless LAN port, and the like), or a power supply terminal for supplying power to the mobile terminal 100. The interface unit 170 may be implemented in the form of a socket for accommodating an external card, such as Subscriber Identification Module (SIM), User Identity Module (UIM), or a memory card for information storage.

FIG. 2B is a rear perspective view of the mobile terminal 100 illustrated in FIG. 2A.

Referring to FIG. 2B, a second camera 121b may be further mounted at a rear surface of the terminal body, namely, the rear case 102. The second camera 121b may have an image capturing direction, which is substantially opposite to the direction of the first camera unit 121a (refer to FIG. 2A), and have a different number of pixels from that of the first camera unit 121a.

For example, it may be preferable that the first camera 121a has a smaller number of pixels to capture an image of the user's face and transmits such image to another party, and the camera 221′ has a larger number of pixels to capture an image of a general object and not immediately transmits it in most cases. The first and the second cameras 121a and 121b may be installed on the terminal body such that they can be rotatable or popped up.

Furthermore, a flash 123 and a mirror 124 may be additionally disposed adjacent to the second camera 121b. When an image of a subject is captured with the camera 121b, the flash 123 may illuminate the subject. The mirror 124 may allow the user to see himself or herself when he or she wants to capture his or her own image (i.e., self-image capturing) by using the camera 121b.

A second audio output unit 153b may be further disposed on the rear surface of the terminal body. The second audio output module 153b may implement stereophonic sound functions in conjunction with the first audio output module 153a (refer to FIG. 2A), and may be also used for implementing a speaker phone mode for call communication.

An antenna (not shown) for receiving broadcast signals may be additionally disposed on a lateral surface of the terminal body in addition to an antenna for making a phone call or the like. The antenna constituting a part of the broadcast receiving module 111 (refer to FIG. 1) may be provided in the terminal body in a retractable manner.

A power supply unit 190 (refer to FIG. 1) for supplying power to the mobile terminal 100 may be mounted on the terminal body. The power supply unit 190 may be incorporated into the terminal body, or may include a battery 191 configured in a detachable manner on the outside of the terminal body. According to the drawing, it is illustrated that the battery cover 103 is combined with the rear case 102 to cover the battery 191, thereby restricting the battery 191 from being released and protecting the battery 191 from external shocks and foreign substances.

An image display device disclosed herein may include both a device for recording and reproducing a video and a device for recording and reproducing an audio.

Hereinafter, a digital television (DTV) will be described as an example of the image display device. However, the image display device disclosed herein may not be limited to the DTV. For example, the image display device may include a set-top box (STB), an Internet protocol TV (IPTV), a personal computer or the like.

FIG. 3 is a conceptual view of a system including an image display device 300 in accordance with the present disclosure.

The system, as illustrated in FIG. 1, may include an image display apparatus 300, a broadcasting station 500 and an Internet 600. The image display apparatus 300 may receive a broadcast signal from the broadcasting station 500 and output the received broadcast signal. Also, the image display apparatus 300 may include a device for accessing the Internet 600 by a transmission control protocol/Internet protocol (TCP/IP).

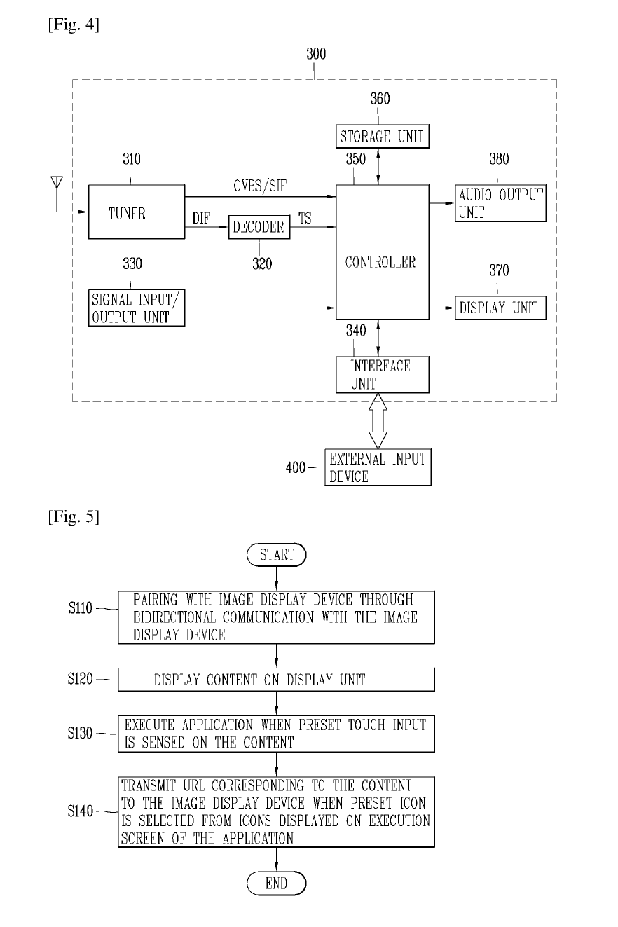

FIG. 4 is a block diagram illustrating an image display apparatus 300 and an external input device 400 according to the present disclosure. The image display apparatus 300 may include a tuner 310, a decoder 320, a signal input/output unit 330, an interface 340, a controller 350, a storage unit 360, a display 370 and an audio output unit 380.

As illustrated in FIG. 4, the tuner 310 may select a radio frequency (RF) broadcast signal, which corresponds to a channel selected by a user, among RF broadcast signals received through an antenna, and convert the selected RF broadcast signal into a medium frequency signal or a baseband image (video)/audio signal. For example, when the RF broadcast signal is a digital broadcast signal, the tuner 310 may convert the RF broadcast signal into a digital IF signal (DIF). On the other hand, when the RF broadcast signal is an analog broadcast signal, the tuner 310 may convert the RF broadcast signal into an analog baseband video/audio signal (CVBS/SIF). The tuner 310 may thus be a hybrid tuner which is capable of processing the digital broadcast signal and the analog broadcast signal.

The digital IF signal (DIF) output from the tuner 310 may be input into the decoder 320, while the analog baseband video/audio signal (CVBS/SIF) output from the tuner 310 may be input into the controller 350. The tuner 310 may receive a single carrier RF broadcast signal according to an advanced television systems committee (ATSC) standard or a multi-carrier RF broadcast signal according to a digital video broadcasting (DVB) standard.

Although the drawing illustrates one tuner 310, the present disclosure may not be limited to this. The image display apparatus 300 may include a plurality of tuners, for example, first and second tuners. In this case, the first tuner may receive a first RF broadcast signal corresponding to a broadcasting channel selected by a user, and the second tuner may receive a second RF broadcast signal corresponding to a pre-stored broadcasting channel in a sequential or periodical manner. Similar to the first tuner, the second tuber may convert an RF broadcast signal into a digital IF signal (DIF) or an analog baseband video or audio signal (CVBS/SIF).

The decoder 320 may receive the digital IF signal (DIF) converted by the tuner 310 and decode the received signal. For example, when the DIF output from the tuner 310 is a signal according to the ATSC standard, the decoder 320 may perform 8-vestigal side band (8-VSB) demodulation. Here, the decoder 320 may also perform channel decoding, such as trellis decoding, de-interleaving, reed Solomon decoding and the like. To this end, the decoder 320 may include a trellis decoder, de-interleaver, a reed Solomon decoder and the like.

As another example, when the digital IF signal (DIF) output from the tuner 310 is a signal according to the DVB standard, the decoder 320 may perform a coded orthogonal frequency division modulation (COFDMA) demodulation. Here, the decoder 320 may also perform convolution decoding, de-interleaving, reed Solomon decoding and the like. To this end, the decoder 320 may include a convolution decoder, a de-interleaver, a reed Solomon decoder and the like.

The signal input/output unit 330 may perform signal input and output operations by being connected to an external device. To this end, the signal input/output unit 330 may include an A/V input/output unit and a wireless communication unit.

The A/V input/output unit may include an Ethernet terminal, a USB terminal, a composite video banking sync (CVBS) terminal, a component terminal, a S-video terminal (analog), a digital visual interface (DVI) terminal, a high definition multimedia interface (HDMI) terminal, a mobile high-definition link (MHL) terminal, an RGB terminal, a D-SUB terminal, an IEEE 1394 terminal, an SPDIF terminal, a liquid HD terminal and the like. Digital signals input through those terminals may be forwarded to the controller 350. Here, analog signals input through the CVBS terminal and the S-video terminal may be forwarded to the controller 350 after being converted into digital signals through an analog-digital converter (not shown).

The wireless communication unit may execute wireless Internet access. For example, the wireless communication unit may execute the wireless Internet access using wireless LAN (WLAN) (Wi-Fi), wireless broadband (Wibro), world interoperability for microwave access (Wimax), high speed downlink packet access (HSDPA) and the like. The wireless communication unit may also perform short-range wireless communication with other electronic devices. For example, the wireless communication unit may perform the short-range wireless communication using Bluetooth, radio frequency identification (RFID), infrared data association (IrDA), ultra wideband (UWB), Zigbee and the like.

The signal input/output unit 330 may transfer to the controller 350 a video signal, an audio signal and a data signal, which are provided from external devices, such as a digital versatile disk (DVD) player, a blu-ray player, a game player, a camcorder, a computer (notebook computer), a portable device, a smart phone and the like. Also, the signal input/output unit 330 may transfer to the controller 350 a video signal, an audio signal and a data signal of various media files, which are stored in an external storage device, such as a memory, a hard disk and the like. In addition, the signal input/output unit 330 may output a video signal, an audio signal and a data signal processed by the controller 350 to other external devices.

The signal input/output unit 330 may perform signal input and output operations by being connected to a set-top box, for example, an Internet protocol TV (IPTV) set-top box via at least one of those various terminals. For instance, the signal input/output unit 330 may transfer to the controller 350 a video signal, an audio signal and a data signal, which have been processed by the IPTV set-top box to enable bidirectional communication, and also transfer signals processed by the controller 350 to the IPTV set-top box. Here, the IPTV may include ADSL-TV, VDSL-TV, FTTH-TV and the like which are divided according to a transmission network.

Digital signals output from the decoder 320 and the signal input/output unit 330 may include a stream signal (TS). The stream signal (TS) may be a signal in which a video signal, an audio signal and a data signal are multiplexed. For example, the stream signal (TS) may be an MPEG-2 transport stream (TS) signal obtained by multiplexing an MPEG-2 video signal and a Dolby AC-3 audio signal. An MPEG-2 TS signal may include a 4-byte header and a 184-byte payload.

The interface 340 may receive an input signal for power control, channel selection, screen setting or the like from an external input device 400 or transmit a signal processed by the controller 350 to the external input device 400. The interface 340 and the external input device 400 may be connected to each other in a wired or wireless manner.

The controller 350 may control an overall operation of the display apparatus 100. For example, the controller 350 may control the tuner 310 to tune an RF broadcast signal corresponding to a user-selected channel or a pre-stored channel. Although not shown, the controller 350 may include a demultiplexer, a video processer, an audio processor, a data processor, an On screen display (OSD) generator and the like.

The controller 350 may demultiplex, for example, an MPEG-2 TS signal into a video signal, an audio signal and a data signal.

The controller 350 may perform a video processing, for example, demodulation (decoding) for a demultiplexed video signal. In more detail, the controller 350 may decode an MPEG-2 encoded video signal using an MPEG-2 decoder, and decode an H.264-encoded DMB or DVB-handheld (DVB-H) signal using an H.264 decoder. Also, the controller 350 may adjust brightness, tint or color of the video signal. The video signal processed by the controller 350 may be transferred to the display 370 or an external output device (not shown) via an external output terminal.

The controller 350 may process, for example, decode a demultiplexed audio signal. In more detail, the controller 350 may decode an MPEG-2 encoded audio signal using an MPEG-2 decoder, an MPEG-4 bit sliced arithmetic coding (BSAC)-encoded DMB audio signal using an MPEG-4 decoder, and an MPEG-2 advanced audio codec (AAC)-encoded DMB or DVB-H audio signal using an AAC decoder. Also, the controller 350 may adjust base, treble and sound volume of the audio signal. The audio signal processed by the controller 350 may be transferred to the audio output unit 380, for example, a speaker, or transferred to an external output device.

The controller 350 may process an analog baseband video/audio signal (CVBS/SIF). Here, the analog baseband video/audio signal (CVBS/SIF) input to the controller 350 may be an analog baseband video/audio signal output from the tuner 310 or the signal input/output unit 330. The processed video signal may be displayed on the display 370 and the processed audio signal may be output through the audio output unit 380.

The controller 350 may process, for example, decode a demultiplexed data signal. Here, the data signal may include electronic program guide (EPG) information, which may include broadcast information, such as start time, end time and the like, related to a broadcast program broadcasted on each channel. The EPG information may include ATSC-program and system information protocol (ATSC-PSIP) information and DVB-service information (DVB-SI) information. The ATSC-PSIP information or DVB-SI information may be included in an MPEG-4 TS header (4 bytes).

The controller 350 may perform on-screen display (OSD) processing. In more detail, the controller 350 may generate an OSD signal for displaying various information as graphic or text data based on at least one of a video signal and a data signal or an input signal received from the external input device 400. The OSD signal may include various data such as a user-interface (UI) screen for the image display device 300 and various menu screens, widgets, icons and the like.

The storage unit 360 may store various programs for signal processing and control by the controller 350, and may also store processed video, audio and data signals. The storage unit 360 may include at least one of a flash memory-type storage medium, a hard disc-type storage medium, a multimedia card micro-type storage medium, a card-type memory (for example, SD or XD memory), a random access memory (RAM), a static random access memory (SRAM), a read-only memory (ROM), electrically erasable programmable ROM (EEPROM), a programmable read-only memory (PROM), a magnetic memory, a magnetic disk and an optical disk.

The display 370 may convert a processed video signal, a processed data signal, and an OSD signal provided by the controller 350 into RGB signals, thereby generating driving signals. The display 370 be implemented into various types of displays such as a plasma display panel, a liquid crystal display (LCD), a thin film transistor-LCD (TFT-LCD), an organic light-emitting diode (OLED), a flexible display, a three-dimensional (3D) display, an e-ink display and the like. The display 370 may also be implemented as a touch screen and may thus be used as an input device.

The audio output unit 380 may receive a processed audio signal (e.g., a stereo signal or a 5.1-channel signal) from the controller 350. The audio output unit 380 may be implemented in various types of speakers.

The external input device 400 may be connected to the interface 340 in a wired or wireless manner so as to transmit an input signal generated in response to a user's input to the interface 340. The external input device 400 may include a remote control device, a mouse, a keyboard and the like. The remote control device may transmit an input signal to the interface using various communication techniques such as Bluetooth, RF, IR, UWB and ZigBee. The remote control device may be a spatial remote control device. The spatial remote control device may generate an input signal by sensing an operation of a main body within a space.

The image display device 300 may be a fixed digital broadcast receiver, capable of receiving at least one of ATSC (8-VSB) broadcast programs, DVB-T (COFDM) broadcast programs, and ISDB-T (BST-OFDM) broadcast programs, or a mobile digital broadcast receiver, capable of receiving at least one of terrestrial DMB broadcast programs, satellite DMB broadcast programs, ATSC-M/H broadcast programs, DVB-H (COFDM) broadcast programs, and Media Forward Link Only (MediaFLO) broadcast programs. Alternatively, the image display device 300 may be an IPTV digital broadcast receiver capable of receiving cable broadcast programs, satellite broadcast programs or IPTV programs.

Meanwhile, the mobile terminal 100 may display a content on a display unit 151. However, a user suffers from viewing the content on a small screen due to the size limitation of the display unit 151. Also, the image display device 300 may also display a content on a display unit 370. However, a user suffers from searching for a content to be output on the image display device 300 due to an inconvenient manipulation of a remote controller.

Hereinafter, description will be thus given of a mobile terminal 100, capable of improving user convenience in outputting a content on an image display device 300, and a control method thereof, with reference to the accompanying drawings.

FIG. 5 is a flowchart for describing one exemplary embodiment of a mobile terminal 100 (see FIG. 1) according to the present disclosure. The mobile terminal 100 may include a wireless communication unit 110 (see FIG. 1), a display unit 151 (see FIG. 1), and a controller 180 (see FIG. 1).

As illustrated in FIG. 5, first, the mobile terminal 100 which performs bidirectional communication with the image display device 300 may be paired with the image display device 300 (S110).

The wireless communication unit 110 of the mobile terminal 100 may perform the bidirectional communication with the image display device 300. That is, the wireless communication unit 110 may receive a wireless signal from the image display device 300 and transmit a wireless signal to the image display device 300.

To this end, the mobile terminal 100 and the image display device 300 may belong to the same network, and perform the bidirectional communication through Wi-Fi direct. Also, at least one of the mobile terminal 100 and the image display device 300 may have a preset application (for example, “WatchBig application”) installed therein. Here, the WatchBig application refers to an application which corresponds to a function of outputting a content to the image display device 300.

When the preset application, namely, the WatchBig application is executed in the mobile terminal 100, the wireless communication unit 110 may search for image display devices, which belong to the same network as the mobile terminal 100. The controller 180 may then display a list of image display devices, which include items corresponding to the searched image display devices, respectively, on an execution screen of the WatchBig application.

Here, when one image display device (e.g., 300) is selected from the list of image display devices, the controller 180 may display a popup window on the display unit 151, such that a user can enter an authentication code involved with the selected image display device 300. Here, the authentication code may also be displayed on the display unit 370 of the image display device 300.

When the authentication code which has been displayed on the display unit 370 of the image display device 300 is entered into the mobile terminal 100 by a user, then the controller 180 may transmit the entered authentication code to a server or the image display device 300. Accordingly, the mobile terminal 100 and the image display device 300 may be paired with each other.

In addition, the mobile terminal 100 may output a notification signal notifying that it has been paired with the image display device 300. For example, the mobile terminal 100 may display the notification signal on the display unit 151 or output the notification signal through the audio output module 153. Similar to this, the image display device 300 may also output the notification signal notifying the pairing with the mobile terminal 100.

Next, a content may be displayed on the display unit 151 (S120).

The display unit 151 of the mobile terminal 100 may display the content. The display unit 151 may display a content stored in the memory 160 (see FIG. 1) of the mobile terminal 100, or a content stored in the server. The controller 180 of the mobile terminal 100 may reproduce (play back) the content, and display the currently-reproduced content on the display unit 151. Also, the controller 180 may display a list of plural contents on the display unit 151. Here, thumbnail images corresponding to the contents may be included in the list of contents.

Afterwards, when a preset touch input is sensed on the content, an application may be executed (S130).

In detail, when a preset touch input is sensed on the content, the controller 180 may display a list of applications, which include items corresponding to a plurality of applications involved with the content. Here, the items included in the list of applications may include items corresponding to a plurality of applications, related to sharing of the touched content (for example, a messenger application, a mail application, a Bluetooth application, the aforementioned WatchBig application, etc.)

The controller 180 may execute an application corresponding to a selected item from the list of applications. For example, if an item corresponding to the WatchBig application is selected from the list of applications, the controller 180 may execute the WatchBig application.

Next, when a preset icon is selected from a plurality of icons displayed on an execution screen of the application, a uniform resource locator (URL) corresponding to the touched content may be transmitted to the image display device 300, such that the content can be output on the image display device 300 (S140).

In response to the execution of the WatchBig application, the display unit 151 may display the execution screen of the WatchBig application. The controller 180 may display information related to the touched content on the execution screen of the WatchBig application. Here, the information related to the content may include at least one of a name, a capacity and a file attribute of the content.

Also, the controller 180 may display information related to the image display device 300, which is currently paired with the mobile terminal 100, on the execution screen of the WatchBig application. Here, the information related to the image display device 300 may include at least one of a model name of the image display device 300, identification information, and a nickname given by the user.

Beside those information, the execution screen of the WatchBig application may include an icon corresponding to a function of outputting the touched content directly onto the image display device 300. Once the icon is selected, the controller 180 may transmit a stream URL corresponding to the content to the image display device 300, together with a control command to output the content directly onto the image display device 300.

Accordingly, the image display device 300 may access the server to search for the content corresponding to the stream URL, and output the searched content on the display unit 370.

As described, according to the present disclosure, the image display device 300 may receive a URL corresponding to a content from the mobile terminal 100. That is, the image display device 300 may receive a URL of an extremely smaller capacity than the very content from the mobile terminal 100. This may result in an efficient use of a battery resource and a data resource of the mobile terminal 100.

According to the present disclosure, the image display device 300 may output the content using the URL of the content which has been received from the mobile terminal 100. This may facilitate the user to search for the content through a touch screen of the mobile terminal 100, and view the searched content on the display unit 370 of the image display device 300. Consequently, the user's convenience can be improved.

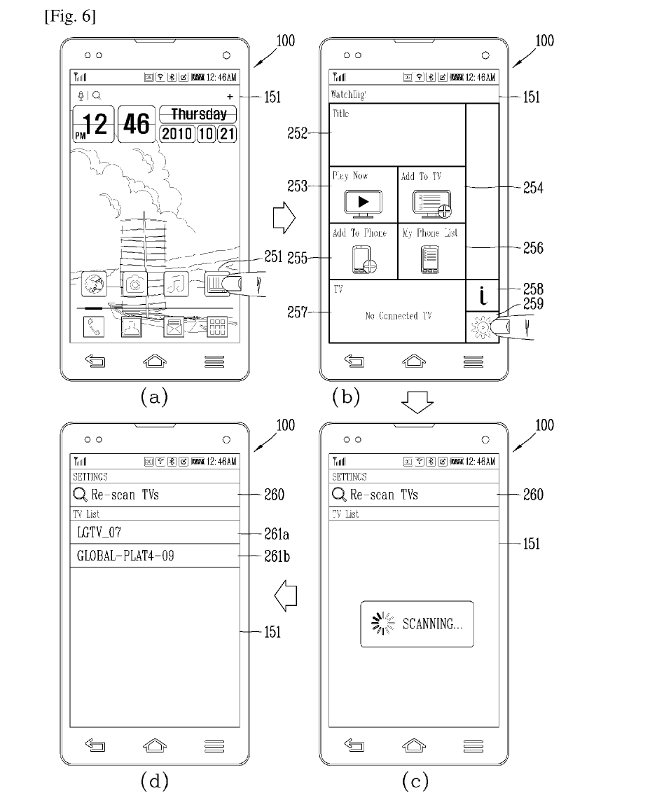

FIGS. 6 to 8 are conceptual views illustrating an exemplary embodiment in which the mobile terminal 100 and the image display device 300 are paired with each other.

As illustrated in FIGS. 6A and 6B, the controller 180 may execute a WatchBig application in response to a user selection. In detail, referring to FIG. 6A, the display unit 151 may display a home screen. Icons corresponding to a plurality of applications, respectively, may be displayed on the home screen.

Here, when one icon 251 (for example, an icon corresponding to the WatchBig application) is selected from the icons, referring to FIG. 6B, the controller 180 may execute the WatchBig application. Accordingly, the display unit 151 may output an execution screen of the WatchBig application. Although not illustrated, when a guide icon 258 output on the execution screen of the WatchBig application is selected, a method of using the WatchBig application may be displayed.

The execution screen of the WatchBig application may include an area 257 for displaying information related to a paired image display device. When there is not a paired image display device, as illustrated, text information indicating the absence of the connected image display device may be displayed on the area 257 for outputting the information related to the image display device.

Here, when an icon 259 (hereinafter, referred to as “setting icon”) corresponding to a function of pairing the mobile terminal 100 with the image display device is selected, as illustrated in FIG. 6C, the display unit 151 may output a setting screen. Simultaneously, the controller 180 may scan image display devices included in the same network as the mobile terminal 100. As illustrated, the setting screen may output a popup window for indicating that the image display devices are being scanned.

As illustrated in FIG. 6D, the controller 180 may display a list of image display devices, which include items 261a and 261b corresponding to the scanned image display devices, respectively, on the setting screen. Also, the controller 180 may display an icon 260, which corresponds to a function of rescanning external input devices, on the setting screen.

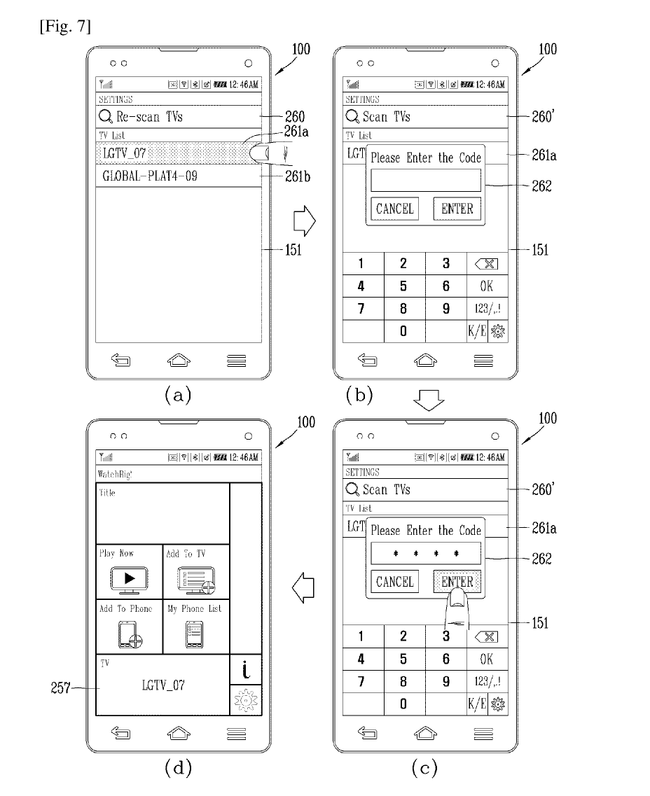

Afterwards, referring to FIG. 7A, when one item 261a (for example, “LGTV_{—}07”) is selected from the items 261a and 261b corresponding to the scanned image display devices, respectively, the controller 180, as illustrated in FIG. 7B, may display a popup window 262 for receiving an authentication code involved with the selected image display device 300. Also, an icon 260′ which corresponds to a function of scanning the external input devices may be output on the setting screen.

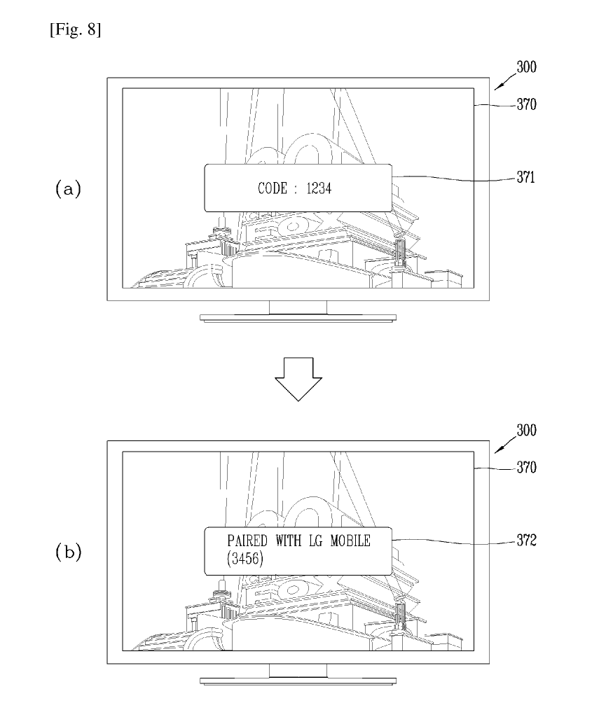

Here, referring to FIG. 8A, the image display device 300 may display an authentication code 371 on the display unit 370. As illustrated, the authentication code 371 may be displayed on a central region of the display unit 370, or although not illustrated, on one side surface of the display unit 370. When a preset time elapses from when the authentication code 371 is displayed on the display unit 370, the authentication code 371 may not be displayed on the display unit 370 any more.

Referring to FIG. 7C, the user may enter the authentication code onto the popup window 262 using a virtual keypad displayed on the mobile terminal 100, with reference to the authentication code 371 output on the display unit 370 of the image display unit 300. The wireless communication unit 110 may transmit the entered authentication code to the server or the image display device 300.

Afterwards, the server or the image display device 300 may check the authentication code received from the mobile terminal 100, and then transmit a pairing function signal to the mobile terminal 100. Accordingly, the mobile terminal 100 and the image display device 300 may be paired with each other. Referring to FIG. 7D, information (for example, “LGTV_{—}07”) related to the image display device 300 paired may be displayed on the area 257 for displaying the information related to the image display device. Referring to FIG. 8B, the display unit 370 of the image display device 300 may also output thereon information 372 related to the mobile terminal 100 paired (for example, “LGMOBILE(3456)”).

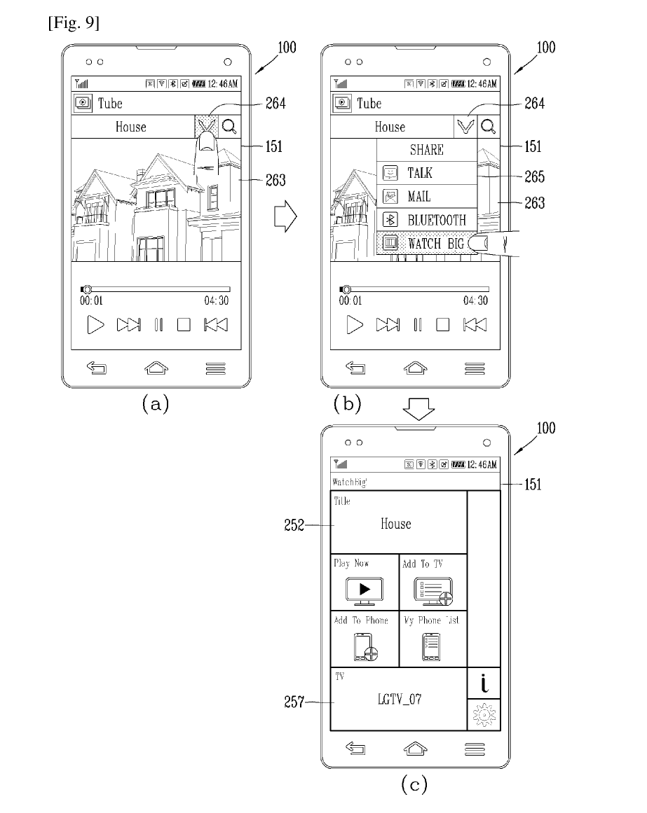

FIGS. 9 to 11 are conceptual views illustrating that a content to be output to the image display device 300 is selected.

As illustrated in FIG. 9A, the controller 180 of the mobile terminal 100 may reproduce a content stored in the server. The controller 180 may reproduce the content using an application for reproducing the content stored in the server. The display unit 151 may display the currently-reproduced content.

Here, when a share icon 264 displayed on the display unit 151 is selected, as illustrated in FIG. 9B, a list 265 of applications, which includes items corresponding to a plurality of applications, respectively, involved with content sharing, may be displayed. As illustrated, the list 265 of applications may include items, which correspond to a messenger application, a mail application, a Bluetooth application and a WatchBig application, respectively.

Here, when an item corresponding to the WatchBig application is selected, as illustrated in FIG. 9C, the controller 180 may execute the WatchBig application. Accordingly, the display unit 151 may display an execution screen of the WatchBig application. As illustrated, the controller 180 may display information 252 related to the content on the execution screen of the WatchBig application. The information 252 related to the content may include at least one of a name (for example, “House”), a capacity and a file attribute of the content.

Also, the controller 180 may display information 257 related to the image display device 300, which has been paired with the mobile terminal 100, on the execution screen of the WatchBig application.

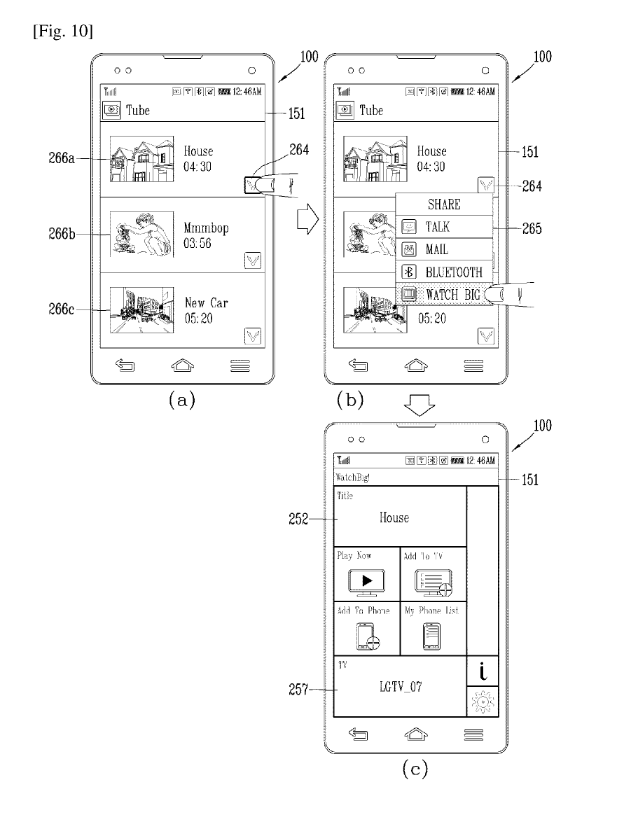

As illustrated in FIG. 10A, the display unit 151 may display a list of contents, which include items 266a to 266c corresponding to the contents stored in the server, respectively. Here, when a share icon 264 included in one item (e.g., 266a) is selected, as illustrated in FIG. 10B, a list 265 of applications including items corresponding to a plurality of applications, respectively, which are involved with content sharing. Here, when an item corresponding to a WatchBig application is selected, as illustrated in FIG. 10C, an execution screen of the WatchBig application may be displayed, and information 252 related to the content may be displayed on the execution screen of the WatchBig application.

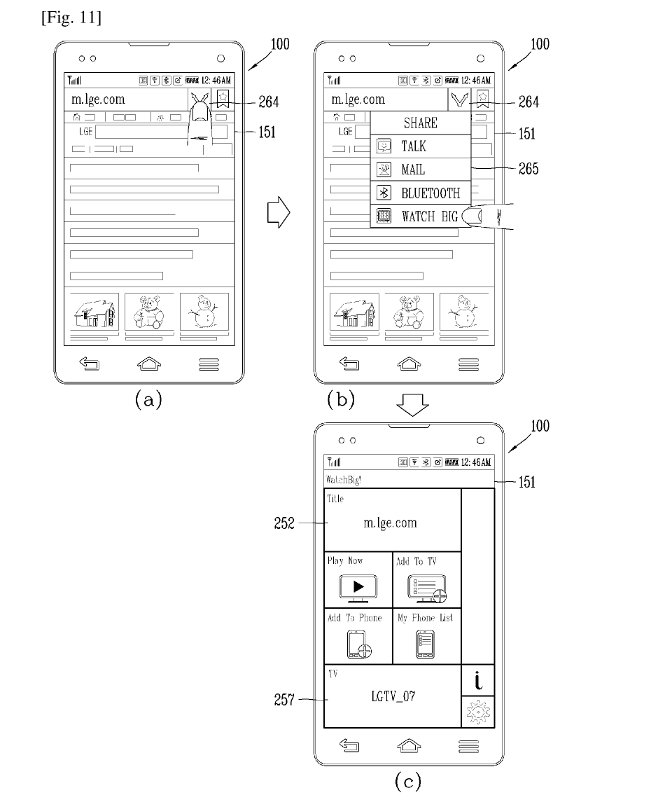

Referring to FIG. 11A, the display unit 151 may display a webpage. Here, when a share icon 264 included in the webpage is selected, as illustrated in FIG. 11B, a list 265 of applications, which include items corresponding to a plurality of applications, respectively, involved with webpage sharing, may be displayed. Here, when an item corresponding to a WatchBig application is selected, as illustrated in FIG. 11C, an execution screen of the WatchBig application may be displayed, and information related to the webpage (for example, a URL of the webpage) may be displayed on an execution screen of the WatchBig application.

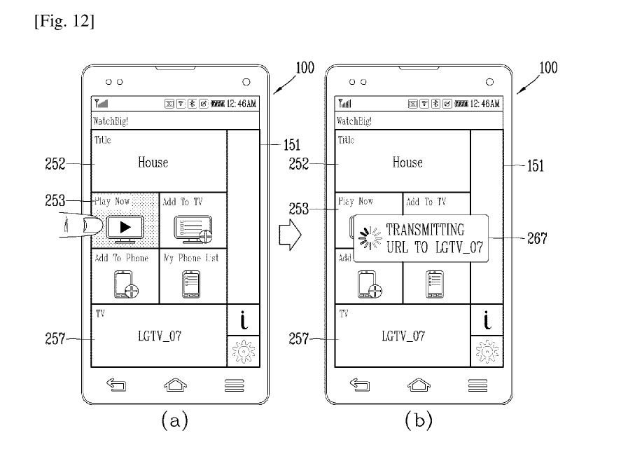

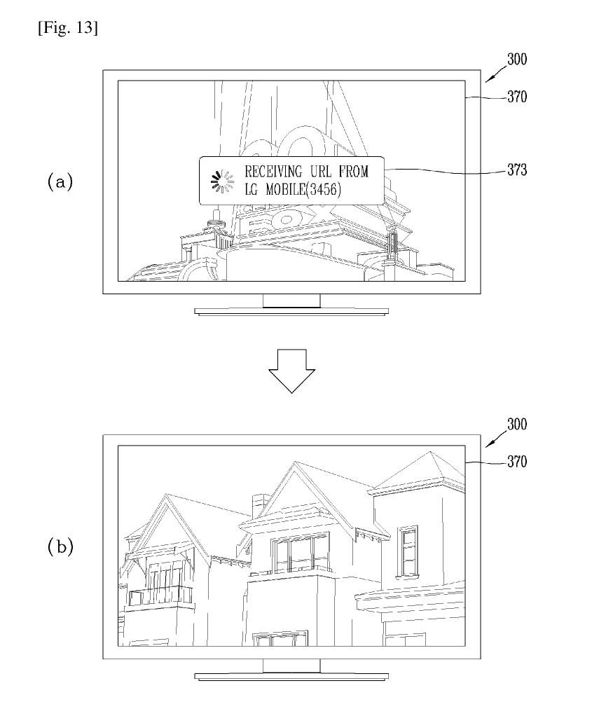

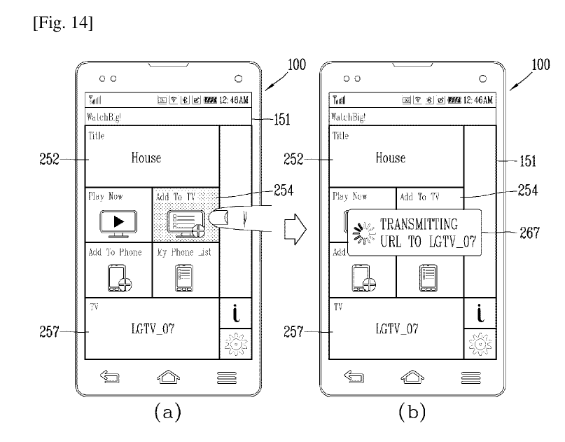

FIGS. 12 and 13 are conceptual views illustrating an exemplary embodiment of outputting a content directly onto the image display device 300.

As illustrated in FIG. 12A, the display unit 151 of the mobile terminal 100 may display an execution screen of a WatchBig application. The execution screen of the WatchBig application may include a first icon 253 corresponding to a function of outputting a content directly to the image display device 300.

Here, when the first icon 253 is selected, as illustrated in FIG. 12B, the controller 180 may transmit a URL corresponding to a content to the image display device 300 paired, together with a control command to output the content directly to the image display device 300. Additionally, the controller 180 may also transmit a control command to execute the WatchBig application to the image display device 300 when the WatchBig application is not executed in the image display device 300.

Accordingly, the display unit 151 may output a popup window 267 indicating that the URL corresponding to the content is being transmitted to the image display device 300.

Referring to FIG. 13A, the image display device 300 may receive, from the paired mobile terminal 100, a control command to output the URL and the content directly to the image display device 300. The display unit 370 of the image display device 300 may output a popup window 373 which indicates that the URL is under reception from the mobile terminal 100.

Referring to FIG. 13B, afterwards, the image display device 300 may access the server to search for the content corresponding to the URL. The display unit 370 of the image display device 300 may stop the output of a currently-output content, and then start to output the searched content.

Here, a controller 350 of the image display device 300 may detect attribute information related to the received URL. The controller 350 may detect whether or not the received URL is a URL involved with a supportable application, and then decide in which form the content is to be displayed on the display unit 370. For example, the controller 350 may detect which application is related to the received URL, among a TED application, a YOUTUBE application and a Daum TVPOT application. If the received URL is not involved with any of those applications, a browser screen may be output to display a webpage screen corresponding to the URL.

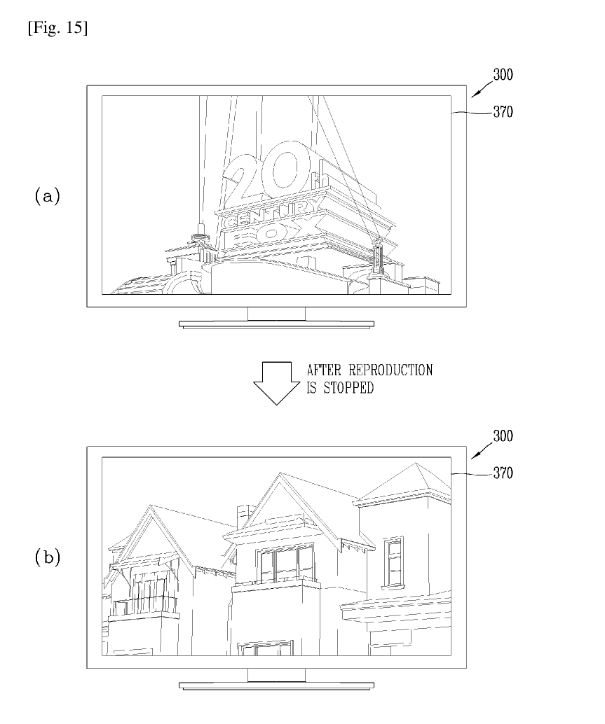

FIGS. 14 and 15 are conceptual views illustrating an exemplary embodiment of adding a content to a reproduction list of the image display device 300.

As illustrated in FIG. 14A, the display unit 151 of the mobile terminal 100 may output an execution screen of a WatchBig application. The execution screen of the WatchBig application may include a second icon 254 corresponding to a function of adding a content to a reproduction list of the image display device 300. Additionally, when the WatchBig application has not been executed in the image display device 300, the controller 180 may also transmit a control command to activate the WatchBig application to the image display device 300.

When the second icon 254 is selected, as illustrated in FIG. 14B, the controller 180 may transmit a URL corresponding to the content to the image display device 300, together with a control command to add the content to the reproduction list of the image display device 300. Accordingly, the display unit 151 may output a popup window 267 indicating that the URL corresponding to the content is in the course of being transmitted to the image display device 300.

Referring to FIG. 15A, the image display device 300 may receive the control command, which indicates the addition of the content to the reproduction list of the image display device 300, from the paired mobile terminal 100. Here, although not illustrated, the display unit 370 of the image display device 300 may output a popup window, which indicates that the content corresponding to the URL received from the mobile terminal 100 has been added to the reproduction list, for a preset time.

Afterwards, referring to FIG. 15B, the display unit 370 of the image display device 300 may stop the output of a currently-output another content, and start to output the content corresponding to the URL received from the mobile terminal 100.

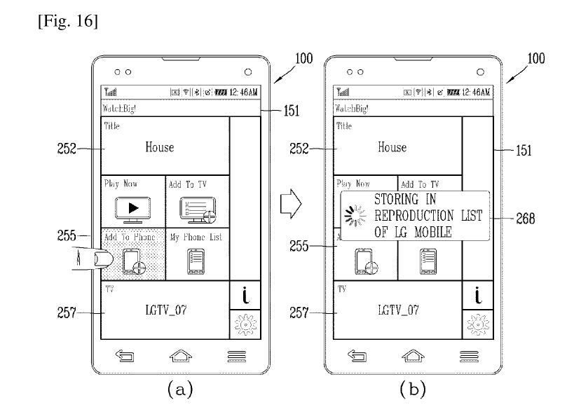

FIG. 16 is a conceptual view illustrating an exemplary embodiment of adding a content to a reproduction list of the mobile terminal 100.

As illustrated in FIG. 16A, the display unit 151 of the mobile terminal 100 may display an execution screen of a WatchBig application. The execution screen of the WatchBig application may include a third icon 255 corresponding to a function of adding a content to a reproduction list of the mobile terminal 100.

Here, when the third icon 255 is selected, as illustrated in FIG. 16B, the controller 180 may store a content in the reproduction list of the mobile terminal 100. Here, the content itself may be stored in the reproduction list of the mobile terminal 100, or a URL corresponding to the content may be stored in the reproduction list of the mobile terminal 100. Accordingly, the display unit 151 may output a popup window 268 indicating that the content is in the course of being stored in the reproduction list of the mobile terminal 100.

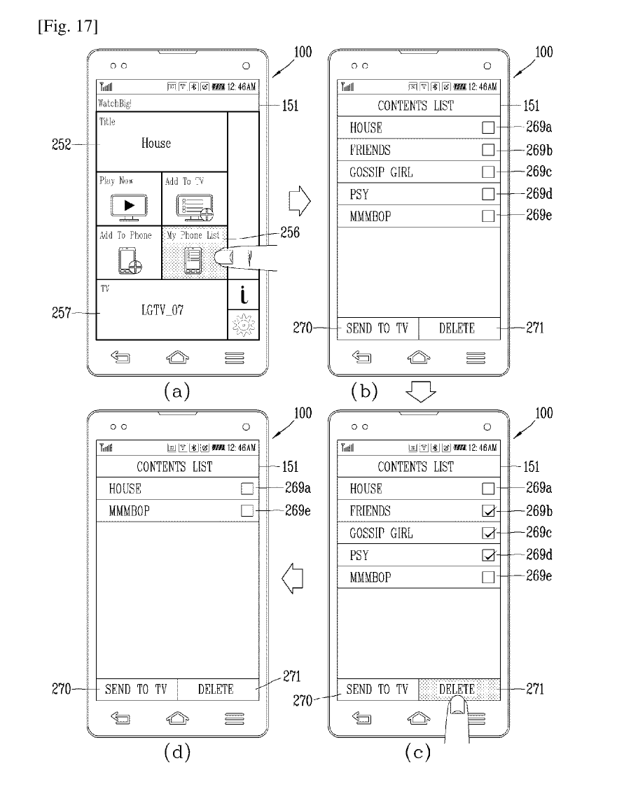

FIGS. 17 to 19 are conceptual views illustrating an exemplary embodiment of displaying a reproduction list of the mobile terminal 100.

As illustrated in FIG. 17A, the display unit 151 of the mobile terminal 100 may output an execution screen of a WatchBig application. The execution screen of the WatchBig application may include a fourth icon 256 corresponding to a function of displaying a reproduction list of the mobile terminal 100.

Here, when the fourth icon 256 is selected, as illustrated in FIG. 17B, the controller 180 may display the reproduction list of the mobile terminal 100. The reproduction list of the mobile terminal 100 may include items 269a to 269e corresponding to previously added contents, respectively. Here, the items 269a to 269e corresponding to the previously added contents may include an icon 269a corresponding to the content added in FIG. 16.

Here, the controller 180 may edit the reproduction list based on a touch input sensed on the reproduction list. As illustrated in FIGS. 17C and 17D, when an icon 271 (hereinafter, referred to “delete icon”) corresponding to a function of deleting an item is selected after selecting at least some (for example, 269b to 269d) of the items 269a to 269e corresponding to the previously added contents, included in the reproduction list, the controller 180 may delete the selected items 269b to 269d from the reproduction list.

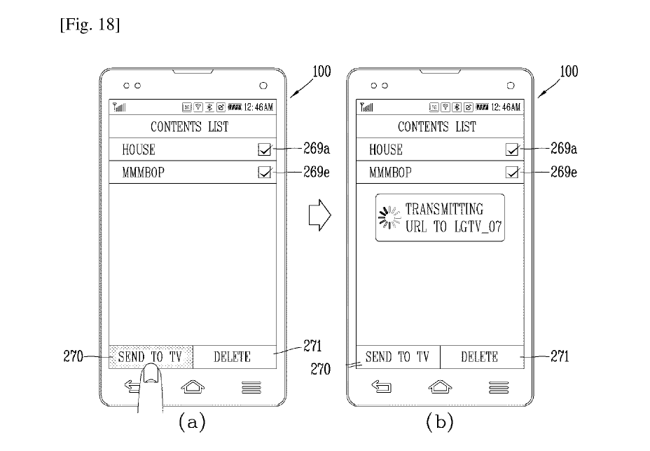

Referring to FIGS. 18A and 18B, after selecting all of the items 269a and 269e left in the reproduction list, when an icon 270 (hereinafter, referred to as “send icon”) corresponding to a function of sending (transmitting) them to the image display device 300, the controller 180 may transmit URLs of the contents corresponding to the selected items 269a and 269e to the image display device 300.

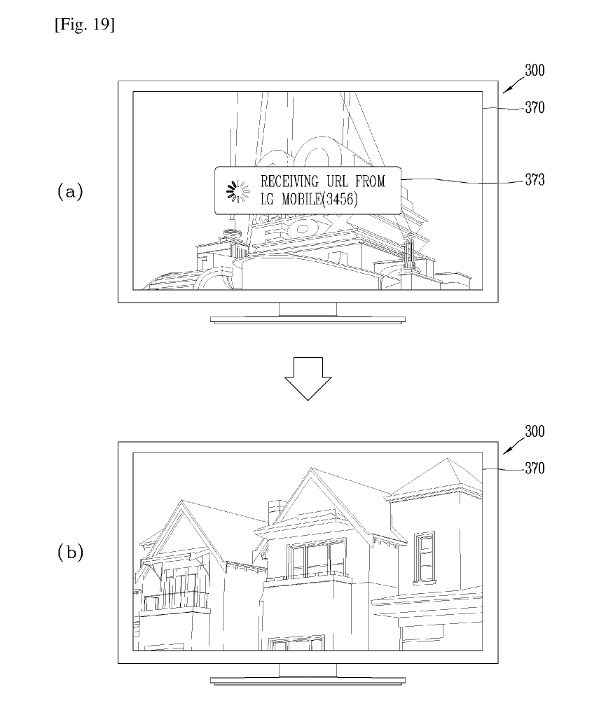

Accordingly, referring to FIG. 19A, the image display device 300 may receive a control command to output the URLs and the contents on the image display device 300, from the mobile terminal 100. The display unit 370 of the image display device 300 may then output a popup window 373 indicating that the URLs are in the course of being received from the mobile terminal 100.

Afterwards, referring to FIG. 19B, the image display device 300 may access the server to search for the contents corresponding to the URLs. The display unit 370 of the image display device 300 may stop the output of the content which has been output, and then start to output the searched contents.

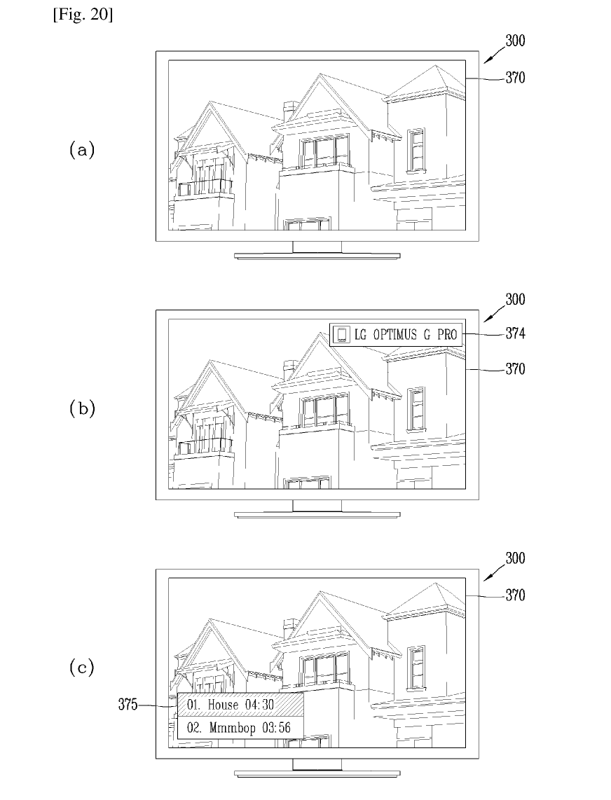

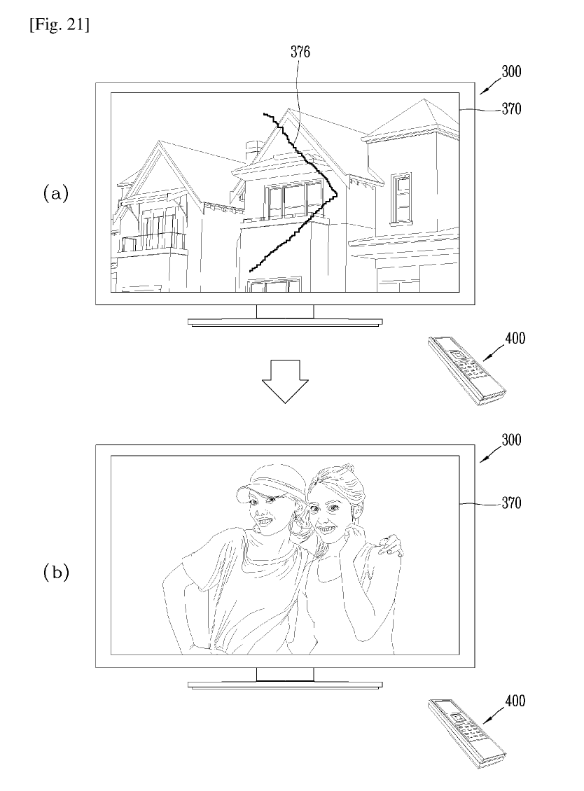

FIGS. 20 and 21 are conceptual views illustrating an exemplary embodiment of outputting a content to the image display device 300.

The controller 350 of the image display device 300, as illustrated in FIG. 20A, may fully display a content corresponding to a received URL on the display unit 370.

Meanwhile, referring to FIG. 20B, the controller 350 may display an advertisement content 374 on the display unit 370, together with the content corresponding to the received URL. Although not illustrated, the controller 350 may output icons (for example, a play icon, a pause icon, a stop icon, etc.), which correspond to functions of controlling the content output to the image display device 300, on the display unit 370.

The controller 350, referring to FIG. 20C, may also display a reproduction list 375 together with the content corresponding to the received URL. Even in this case, although not illustrated, the controller 350 may display icons corresponding to functions of controlling the content, which is output on the image display unit 300, on the display unit 370.

Referring to FIGS. 21A and 21B, the display unit 370 of the image display device 300 may output a content. Here, when an input signal in a preset shape (for example, “>”) is received from an external input device 400, the image display device 300 may stop the output of a currently-output content, and output a content, which is listed to be reproduced the next in the reproduction list.

In the meantime, although not illustrated, when an input signal in a preset shape (for example “<”) is received from an external input device 400, the image display device 300 may stop the output of a currently-output content, and then output a content which is listed in the preceding sequence in the reproduction list.

As described above, the image display device 300 may be controlled based on the input signal received from the external input device 400, an externally-received voice signal, an input with respect to icons displayed on the display unit 370, and the like.

With diversification of functions, the image display device 300 is implemented in the form of a multimedia device having complicated functionalities. That is, the image display device 300 may be implemented to execute various functions in addition to the function of outputting contents. However, a user has suffered from controlling the image display device 300, due to a limited manipulation of a remote controller 400.

Hereinafter, description will thus be given of a mobile terminal 100, which is capable of improving user convenience in controlling an image display device 300, and a control method thereof, with reference to the accompanying drawings.

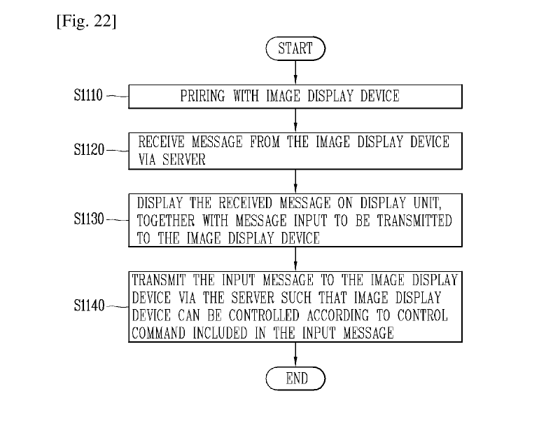

FIG. 22 is a flowchart for describing another exemplary embodiment of a mobile terminal 100 (see FIG. 1) according to the present disclosure. The mobile terminal 100 may include a wireless communication unit 110 (see FIG. 1), a display unit 151 (see FIG. 1), and a controller 180 (see FIG. 1).

As illustrated in FIG. 22, first, the mobile terminal 100 which performs bidirectional communication with the image display device 300 may be paired with the image display device 300 (S1110).

The wireless communication unit 110 of the mobile terminal 100 may perform the bidirectional communication with the image display device 300. That is, the wireless communication unit 110 may receive a wireless signal from the image display device 300 and transmit a wireless signal to the image display device 300.

To this end, the mobile terminal 100 and the image display device 300 may belong to the same network, and perform the bidirectional communication through Wi-Fi direct. Also, the mobile terminal 100 and the image display device 300 may belong to different networks from each other.

Also, at least one of the mobile terminal 100 and the image display device 300 may have a preset application (for example, “WatchBig application”) installed therein. Here, the watch bit application refers to an application which corresponds to a function of controlling the image display device 300 using the mobile terminal 100.

As one exemplary embodiment in which the mobile terminal 100 and the image display device 300 are paired with each other, when a WatchBig application as a preset application is executed in the mobile terminal 100, the wireless communication unit 110 may search for image display devices belonging to the same network as the mobile terminal 100. The controller 180 may display a list of image display devices, which include items corresponding to the searched image display devices, respectively, on an execution screen of the WatchBig application.

Here, when one image display device 300 is selected from the list of image display devices, the controller 180 may output a popup window on the display unit 151, such that a user can enter an authentication code involved with the selected image display device 300. Here, the authentication code may also be displayed on the display unit 370 of the image display device 300.

When the authentication code displayed on the display unit 370 of the image display device 300 is entered into the mobile terminal 100 by the user, the controller 180 may transmit the entered authentication code to a server or the image display device 300. Accordingly, the mobile terminal 100 and the image display device 300 may be paired with each other.

Meanwhile, as another exemplary embodiment in which the mobile terminal 100 and the image display device 300 are paired with each other, even when the mobile terminal 100 and the image display device 300 do not belong to the same network, the controller 180 may output a popup window on the display unit 151, such that the user can enter the authentication code. Here, the authentication code may also be output on the display unit 370 of the image display device 300 for a preset time.

When the authentication code displayed on the display unit 370 of the image display device 300 is entered into the mobile terminal 100 by the user, the controller 180 may transmit the entered authentication code and a specific code of the mobile terminal 100 to the server. The server may store a specific code and an authentication code of the image display device 300. Accordingly, the mobile terminal 100 and the image display device 300 may be paired with each other.

In addition, the mobile terminal 100 may output a notification signal notifying that it has been paired with the image display device 300. For example, the mobile terminal 100 may display the notification signal on the display unit 151, or output the notification signal through the audio output module 153. Similarly, the image display device 300 may also output a notification signal notifying the pairing with the mobile terminal 100.

Also, the mobile terminal 100 and the image display device 300 may be automatically paired with each other later.

Next, the mobile terminal may receive a message from the image display device 300 via the server (S1120).

The mobile terminal 100 and the image display device 300 may transmit and receive messages to and from each other via the server. In detail, when a chat client of the mobile terminal 100 transmits a message, the server may process the message to be interpretable by the image display device 300, and transmit the processed message to the image display device 300. Similarly, when the image display device 300 transmits a message, the server may process the message to be interpretable by the chat client of the mobile terminal 100, and transmit the processed message to the chat client. The chat client may obtain necessary information from the received message and display the obtained information on the display unit 151.

By the aforementioned method, the mobile terminal 100 may receive a message from the image display device 300.

Afterwards, the received message and an input message may be displayed together (S1130).

The controller 180 of the mobile terminal 100 may execute a messenger application.

In this case, the controller 180 may output the received message on an execution screen of the messenger application. The controller 180 may allow the user to input a response message to the received message on the execution screen of the messenger application. Accordingly, both the received message and the input message may be output on the execution screen of the messenger application.

Next, the input message may be transmitted to the image display device 300 via the server such that the image display device 300 can be controlled according to a control command included in the input message (S1140).

For example, the controller 180 may transmit a message, which includes a URL corresponding to a content, to the image display device 300 via the server, such that the image display device 300 can be controlled in association with the content. In addition to this, the controller 180 may also transmit a control command to execute a WatchBig application to the image display device 300 when the WatchBig application has not been executed in the image display device 300.

In detail, when a preset touch input is sensed on the content, the controller 180 may display a list of applications, which include items corresponding to a plurality of applications, respectively, related to the content. Here, the items included in the list of applications may include items, which correspond to a plurality of applications related to sharing of the touched content (for example, a messenger application, a mail application, a Bluetooth application, the aforementioned WatchBig application, etc.)

Here, when an item corresponding to the WatchBig application is selected from the list of applications, the controller 180 may transmit a stream URL corresponding to the content to the image display device 300, together with a control command to output the content directly onto the image display device 300. Here, the stream URL may be transmitted by using P2P, such as WebRTC or the like. The controller 180 may display a message including the stream URL corresponding to the content on the execution screen of the messenger application.

In response to this, the image display device 300 may access the server to search for the content corresponding to the stream URL, and output the searched content to the display unit 370.

In addition to this, the controller 180 may also transmit messages including various control commands to the image display device 300 via the server.

As described above, according to the present disclosure, the mobile terminal 100 may receive information, which is related to a content currently-reproduced on the image display device 300, from the image display device 300 via the server. This may facilitate the user of the mobile terminal 100 to acquire content-related information in the form of message.

According to the present disclosure, the mobile terminal 100 may transmit a control command for controlling the image display device 300 to the image display device 300. This may allow the user to easily control the image display device 300 using a touch screen of the mobile terminal 100 without use of an external input device 400 (for example, a remote controller), resulting in an improvement of user convenience.

Also, the control method using the server may enable the image display device 300 and the mobile terminal 100 to be paired with each other via a sharing device within the same space (for example, at home).

In another example, when the mobile terminal 100 is connected to a data communication network at the outside of a house and the image display device 300 is connected to an Internet as another communication network in the house, the mobile terminal 100 and the image display device 300 may be able to perform bidirectional communication with each other via a server. In more detail, when the mobile terminal is located outside in a data communication-enabled state using a 3G or 4G communication network and the image display device 300 is located at home in an Internet-connected state, an instruction may be delivered from the mobile terminal 100 to the image display device 300 via a server (for example, TV server). Also, a response to the instruction may be delivered from the image display device 300 to the mobile terminal 100, which is connected to the 3G or 4G communication network, via the server. Hereinafter, various exemplary embodiments of the control method illustrated in FIG. 22 will be described, and those exemplary embodiments will be applicable to both the case where the image display device 300 and the mobile terminal 100 are paired with each other via the sharing device (server) within the same space (for example, at home), and the case where the mobile terminal 100 is connected to the data communication network at the outside of the house and the image display device 300 is connected to the Internet as another communication network in the house.

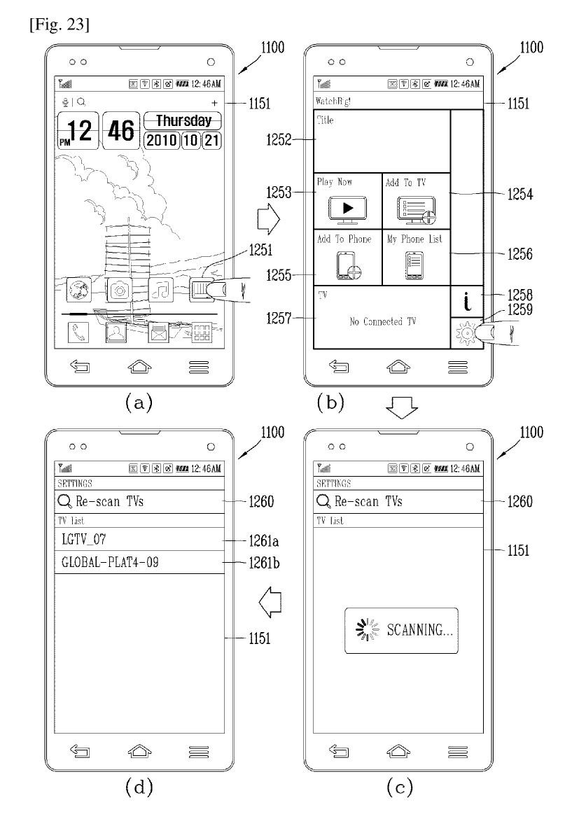

FIGS. 23 to 25 are conceptual views illustrating an exemplary embodiment that a mobile terminal 1100 and an image display device 1300 are paired with each other.

As illustrated in FIGS. 23A and 23B, a controller may execute a WatchBig application based on a user selection. In detail, as illustrated in FIG. 23A, a display unit 1151 may output a home screen thereon. Icons corresponding to a plurality of applications, respectively, may be displayed on the home screen.

Here, when one icon 1251 (for example, an icon corresponding to a WatchBig application) is selected from the icons, referring to FIG. 23B, the controller may execute the WatchBig application. In turn, the display unit 151 may display an execution screen of the WatchBig application. Although not illustrated, when a guide icon 1258 displayed on the execution screen of the WatchBig application is selected, a method of using the WatchBig application may be displayed.

The execution screen of the WatchBig application may include an area 1257 for displaying information related to a paired image display device. When there is not a paired image display device, as illustrated, text information indicating the absence of the connected image display device may be displayed on the area 1257 for outputting the information related to the image display device.

Here, when an icon 1259 (hereinafter, referred to as “setting icon”) corresponding to a function of pairing the mobile terminal 1100 with the image display device is selected, as illustrated in FIG. 23C, the display unit 1151 may output a setting screen. Simultaneously, the controller may scan image display devices included in the same network as the mobile terminal 1100. As illustrated, the setting screen may output a popup window for indicating that the image display devices are being scanned.

Afterwards, as illustrated in FIG. 23D, the controller may display a list of image display devices which include items 1261a and 1261b corresponding to the scanned image display devices on the setting screen. Also, the controller may display an icon 1260, which corresponds to a function of rescanning external input devices, on the setting screen.

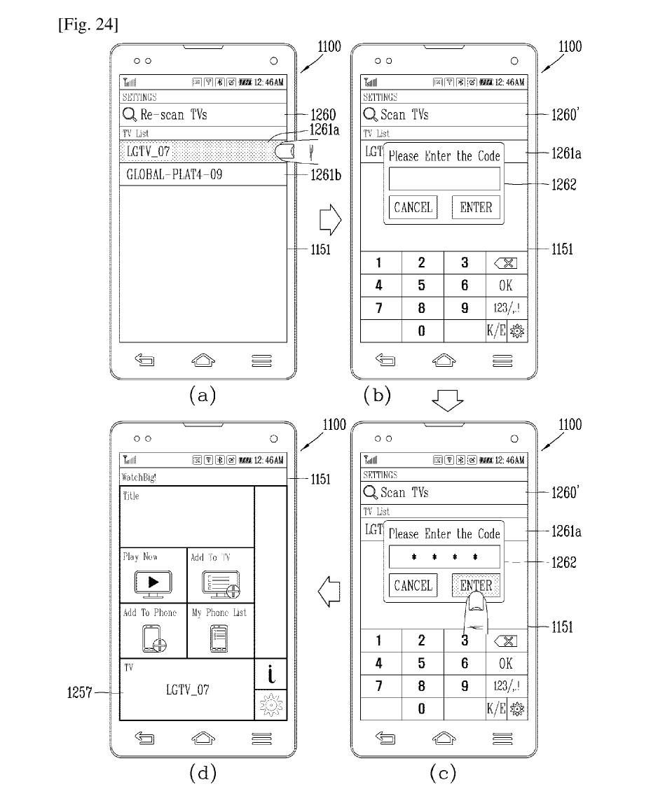

Afterwards, referring to FIG. 24A, when one item 1261a (for example, “LGTV_{—}07”) is selected from the items 1261a and 1261b corresponding to the scanned image display devices, respectively, as illustrated in FIG. 24B, the controller may output a popup window 1262 for receiving an authentication code involved with the selected image display device 1300. Also, an icon 1260′ which corresponds to a function of scanning the external input devices may be output on the setting screen.

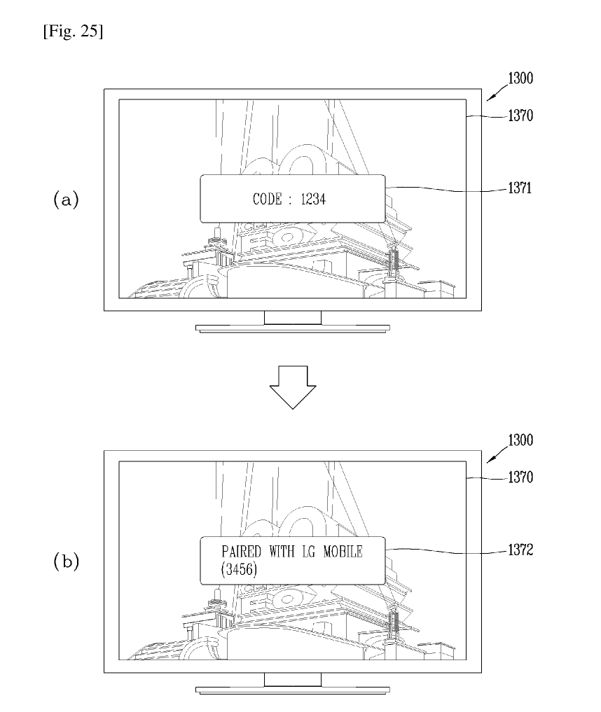

Here, referring to FIG. 25A, the image display device 1300 may display an authentication code 1371 on a display unit 1370. As illustrated, the authentication code 1371 may be displayed on a central region of the display unit 1370, or although not illustrated, displayed on one side surface of the display unit 1370. When a preset time elapses from when the authentication code 371 is displayed on the display unit 1370, the authentication code 1371 may not be output on the display unit 1370 any more.

Referring to FIG. 24C, the user may enter the authentication code 1371 onto a popup window 1262 using a virtual keypad displayed on the mobile terminal 1100, with reference to the authentication code 1371 output on the display unit 1370 of the image display unit 1300. A wireless communication unit may transmit the entered authentication code to the server or the image display device 1300.

Afterwards, the server or the image display device 1300 may check the authentication code received from the mobile terminal1 100, and then transmit a pairing function signal to the mobile terminal 1100. Accordingly, the mobile terminal 1100 and the image display device 1300 may be paired with each other. Referring to FIG. 24D, information (for example, “LGTV_{—}07”) related to the paired image display device 1300 may be displayed on the area 1257 for displaying the information related to the image display device. Referring to FIG. 25B, the display unit 1370 of the image display device 1300 may also output thereon information 1372 (for example, “LGMOBILE(3456)”) related to the paired mobile terminal 1100.

Meanwhile, although the drawings illustrate the exemplary embodiment that the mobile terminal 1100 and the image display device 1300 belong to the same network, even when the mobile terminal 1100 and the image display device 1300 belong to different networks from each other, the mobile terminal 1100 and the image display device 300 may be paired by using the authentication code entered in the mobile terminal 1100.

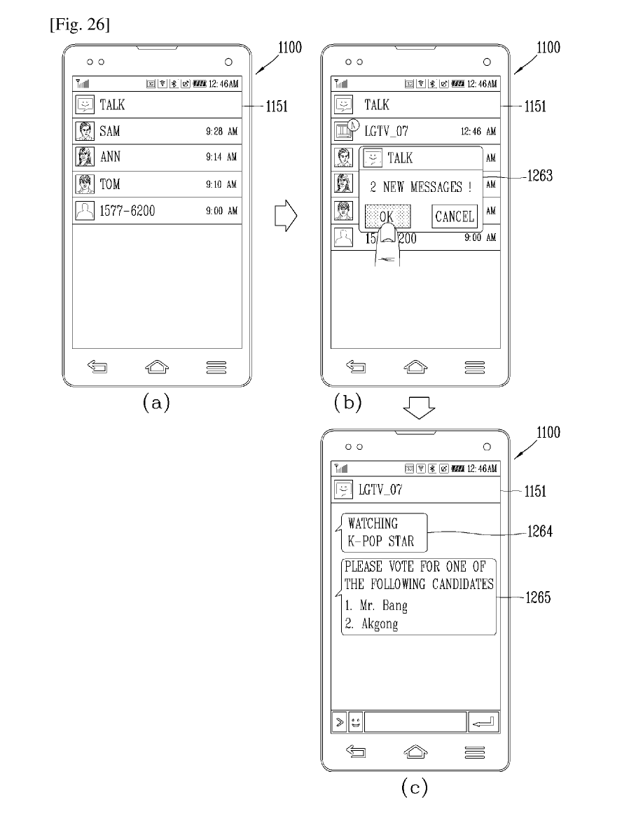

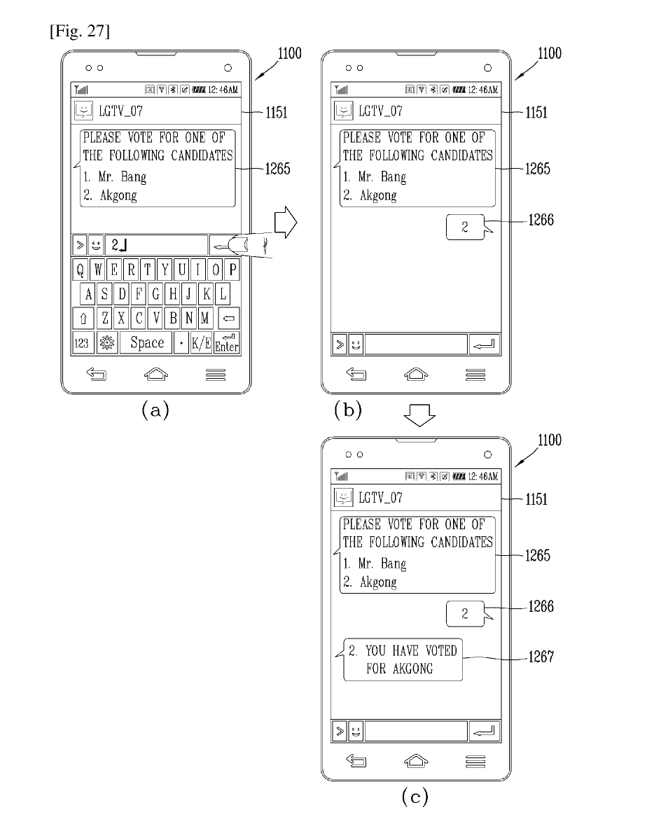

FIGS. 26 and 27 are conceptual views illustrating an exemplary embodiment of transmitting and receiving messages to and from the image display device 1300.

As illustrated in FIG. 26A, the controller 180 (see FIG. 1) may execute a messenger application. Here, when a message is received from the image display device 1300 or a server, as illustrated in FIG. 26B, the controller 180 may display the received message as a message 1263, which has a form related to the messenger application executed.

That is, as illustrated, while “Talk application” is executed, the controller 180 may process the received message into a message related to the talk application and output the processed message to the display unit 151. Although not illustrated, while “SMS application” is executed, the controller 180 may process the received message into a message related to the SMS application and output the processed message to the display unit 1151.

As illustrated in FIG. 26B, a popup window 1263, which indicates a message reception from the image display device 1300, may be output on the display unit 1151. When a touch input is sensed on the popup window 1263, as illustrated in FIG. 26C, the controller 180 may display messages 1264 and 1265 (hereinafter, referred to as “first and second messages”), which have been received from the image display device 1300 via the server, on an execution screen of the talk application.

For example, the first and second messages 1264 and 1265 received from the image display device 1300 may include information related to a content, which is currently output on the image display device 300. As illustrated, the first and second messages 1264 and 1265 may be messages requesting for a user's vote, in relation to the content currently output on the image display device 1300.

Afterwards, referring to FIGS. 27A and 27B, the user may input a message 1266 (hereinafter, referred to as “third message”), in response to the first and second messages 1264 and 1265, through a virtual keypad. Although the drawings illustrate the exemplary embodiment of inputting the third message through the virtual keypad, the controller 180 may also receive the third message 1266 in the form of a voice signal through the microphone 122 (see FIG. 1).

The input third message 1266 may then be transmitted to the image display device 300 via the server. On the other hand, the input third message 1266 may also be transmitted only to the server.

Then, as illustrated in FIG. 27C, the controller 180 may receive a vote check message 1267 (hereinafter, referred to as “fourth message”) from the image display device 300 via the server. On the other hand, the fourth message 1267 may be received directly from the server.

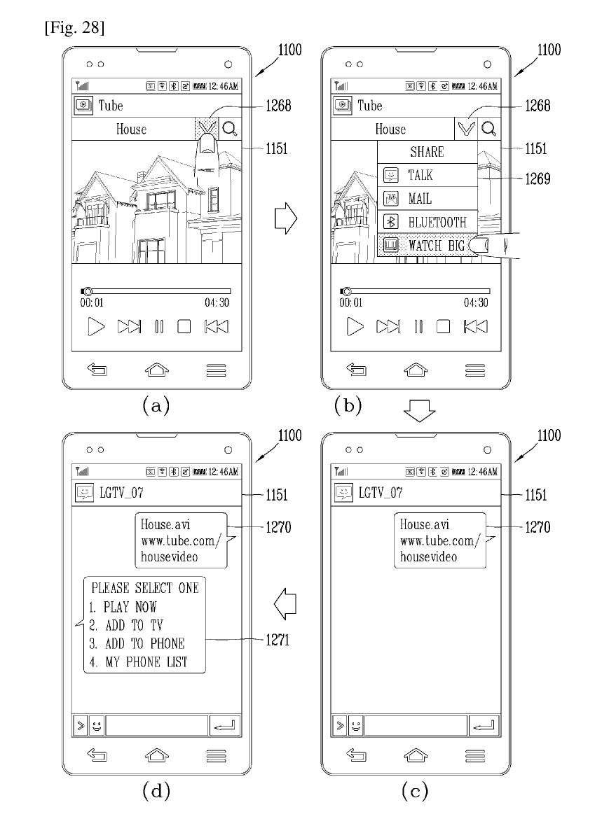

FIGS. 28 to 31 are conceptual views illustrating an exemplary embodiment that a content is output directly to the image display device 1300.

FIG. 28A, the controller 180 of the mobile terminal 1100 may reproduce a content stored in the server. The controller 180 may reproduce the content using an application for reproducing the content stored in the server. The display unit 1151 may output the content which is being reproduced.

Here, when a share icon 1268 displayed on the display unit 1151 is selected, as illustrated in FIG. 28B, a list 1269 of applications, which include items corresponding to a plurality of applications, respectively, related to content sharing, may be displayed. The list 1269 of applications may include a messenger application, a mail application, a Bluetooth application, a WatchBig application, and the like.

Here, when an item corresponding to the WatchBig application is selected, as illustrated in FIG. 28C, the controller 180 may transmit a message including URL information corresponding to the content to the image display device 1300 via the server. Accordingly, the display unit 1151 may output a message 1270 (hereinafter, referred to as “first message”), which includes the URL information corresponding to the content, on an execution screen of the WatchBig application.

Afterwards, referring to FIG. 28D, the controller 180 may receive a message 1271 (hereinafter, referred to as “second message”) for selecting (determining) whether or not to reproduce the content, from the image display device 1300 via the server.

As illustrated, the second message 1271 may include a plurality of selection items. The selection items may include at least one of a first item corresponding to a function of outputting a content directly to the image display device 1300, a second item corresponding to a function of adding a content to a reproduction list of the image display device 1300, a third item corresponding to a function of adding a content to a reproduction list of the mobile terminal 1100, and a fourth item corresponding to a function of displaying a reproduction list of the mobile terminal 1100.

Afterwards, although not illustrated, the user may input a message (not shown) (hereinafter, referred to as “third message”), in response to the second message 1271 including the selection items, via the virtual keypad. The user may also input the third message through the microphone 122. The input third message may be transmitted to the image display device 1300 via the server.

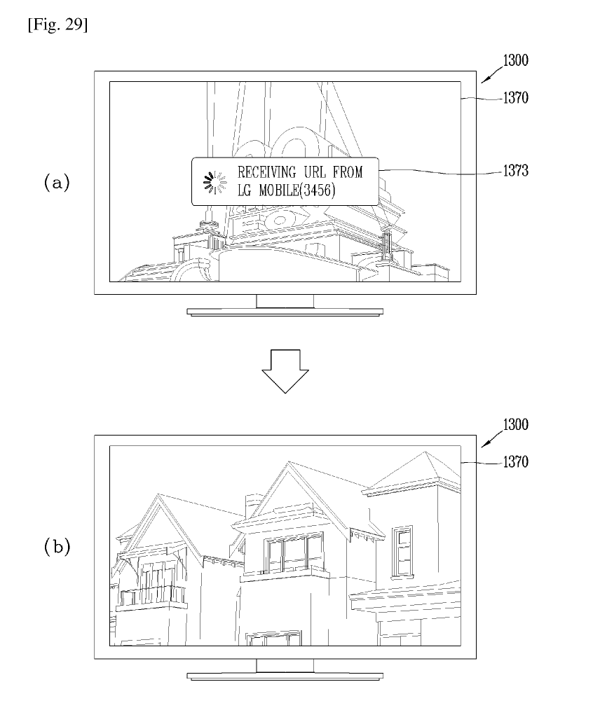

For example, when the third message which includes the “first item” is transmitted by the user to the image display device 1300, as illustrated in FIG. 29A, the image display device 1300 may receive a control command to output a URL and a content directly to the image display device 1300, from the paired mobile terminal 1100. The display unit 1370 of the image display device 1300 may output a popup window 1373 indicating that the URL is being received from the mobile terminal 1100.

Referring to FIG. 29B, the image display device 1300 may access the server to search for the content corresponding to the URL. The display unit 1370 of the image display device 1300 may stop the output of a currently-output content, and start to output the searched content.

Here, the controller 1350 of the image display device 1300 may detect attribute information related to the received URL. The controller 1350 may detect whether or not the received URL is a URL related to a supportable application, and decide in which form the content is to be displayed on the display unit 1370. For example, the controller 1350 may detect which application is related to the received URL, among a TED application, a YOUTUBE application and a Daum TVPOT application. If the received URL is not related to any of those applications, a browser screen may be output to display a webpage screen corresponding to the URL.

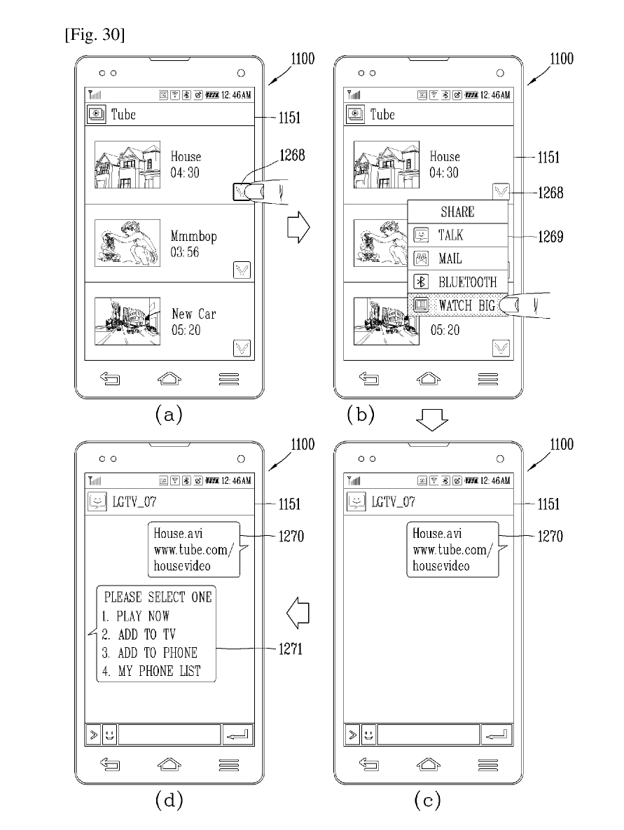

Meanwhile, as illustrated in FIG. 30A, the display unit 1151 may output a list of contents including items, which correspond to contents, respectively, stored in the server. Here, when a share icon 1268 included in one item is selected, as illustrated in FIG. 30B, a list 1269 of applications, which include items corresponding to a plurality of applications, respectively, related to content sharing, may be displayed. Here, when an item corresponding to a WatchBig application is selected, as illustrated in FIG. 30C, the controller 180 may transmit a message including URL information corresponding to the content to the image display device 1300 via the server. Afterwards, referring to FIG. 30D, the controller 180 may receive a message 1271, which includes selection items for selecting (determining) whether or not to reproduce the content, from the image display device 1300 via the server.

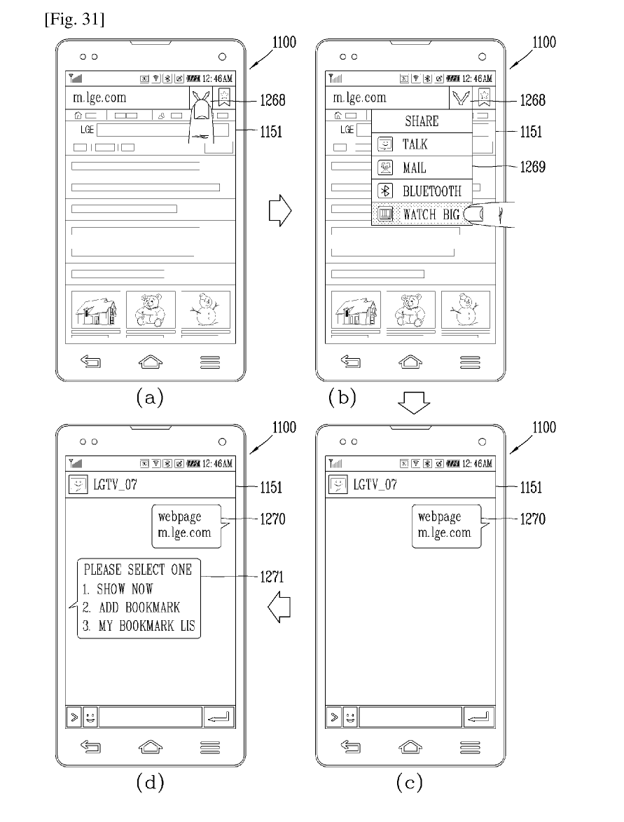

As illustrated in FIG. 31A, the display unit 1151 may output a webpage. Here, when a share icon 1268 included in the webpage is selected, as illustrated in FIG. 31B, a list 1269 of applications, which include items corresponding to a plurality of applications, related to webpage sharing, may be displayed. Here, when an item corresponding to a WatchBig application is selected, as illustrated in FIG. 31C, the controller 180 may transmit a message including URL information corresponding to the content to the image display device 1300 via the server. Afterwards, as illustrated in FIG. 31D, the controller 180 may receive a message 1271, which includes selection items for selecting (determining) whether or not to output the content, from image display device 1300 via the server.

Here, the selection items may include at least one of a first item corresponding to a function of outputting a content directly to the image display device 1300, a second item corresponding to a function of adding a content to a bookmark, and a third item corresponding to a function of displaying a list of bookmarks.

Although FIGS. 29 to 31 illustrate the exemplary embodiment of selecting the share icon 1268, even when the content is moved to a messenger application using a touch input of drag & drop, the controller 180 may transmit the message, which includes the URL information corresponding to the content, to the image display device 1300 via the server.

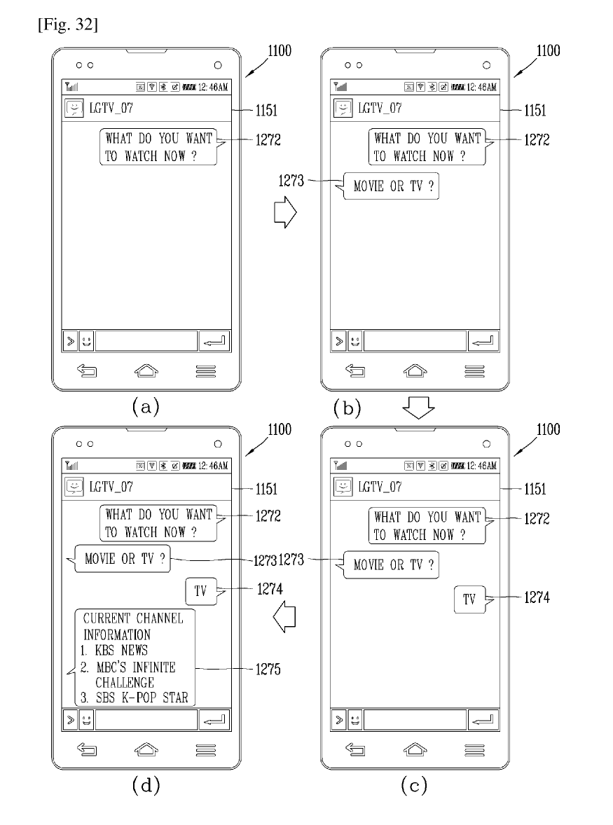

FIGS. 32 to 39 are conceptual views illustrating an exemplary embodiment of transmitting and receiving control-related messages to and from the image display device 1300.

As illustrated in FIG. 32, the image display device 1300 may transmit a message, which includes information related to a plurality of outputtable channels, to the mobile terminal 1100.

In detail, referring to FIG. 32A, the user may execute a messenger application directly on the mobile terminal 1100 or execute the messenger application through a WatchBig application. The user may transmit a message 1272 (hereinafter, referred to as “first message”), which requests for an attribute of a content, which is outputtable by the image display device 1300, to the image display device 1300 via the server using a virtual keypad while the execution screen of the messenger application is displayed.

Then, as illustrated in FIG. 32B, the image display device 1300 may transmit a message 1273 (hereinafter, referred to as “second message”), which indicates that a movie content and a TV content are outputtable, to the mobile terminal 1100 via the server.

Afterwards, as illustrated in FIG. 32C, the user may transmit a message 1274 (hereinafter, referred to as “third message”), which requests for the image display device 1300 to output the TV content, to the image display device 1300 via the server, in response to the second message 1273.

As illustrated in FIG. 32D, the image display device 1300 may then transmit a message 1275 (hereinafter, referred to as “fourth message”), which includes information related to a plurality of channels currently-outputtable, to the mobile terminal 1100 via the server.

Although not shown, when the user transmits the message including the channel information to the image display device 1300, then the image display device 1300 may output a content corresponding to the channel information included in the received message.

Also, the drawings illustrate that the image display device 1300 transmits the fourth message 1275 including the plurality of channel information, but the image display device 1300 may also transmit the fourth message 1275, which includes content recommendation information based on use pattern information of the user, among those outputtable contents.

To this end, the image display device 1300 may analyze user information related to the paired mobile terminal 1100, and recommend a content based on use pattern information of the user. For example, the image display device 1300 may recommend different contents based on user age information, and block outputting of some contents on the user basis.

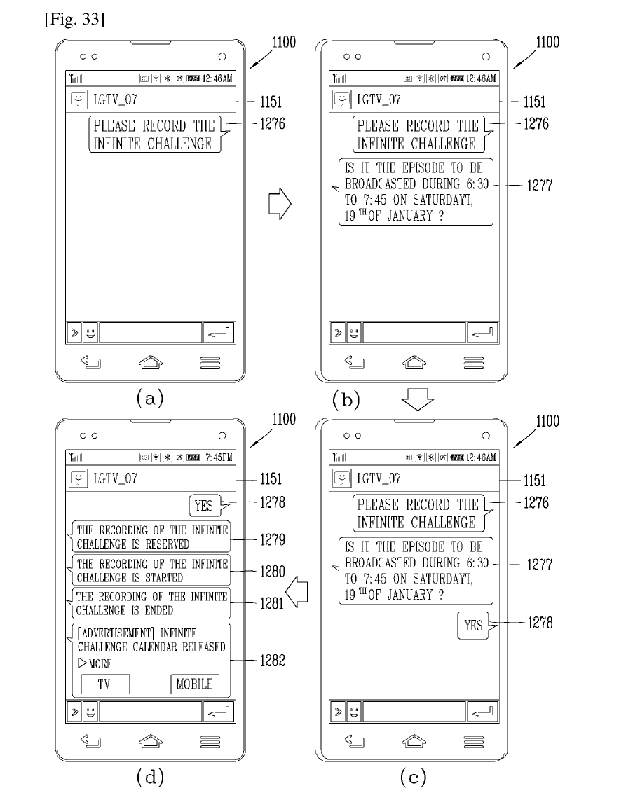

As illustrated in FIG. 33, the image display device 1300 may transmit a message including an advertisement content to the mobile terminal 1100.

In detail, as illustrated in FIG. 33A, the user may transmit a message 1276 (hereinafter, referred to as “first message”), which requests for the image display device 1300 to record a program, to the image display device 1300 via the server, using a virtual keypad, while an execution screen of the messenger application is displayed. Although not illustrated, the user may also transmit a message, which requests for notifying a start of a desired program, to the image display device 1300 via the server.

As illustrated in FIG. 33B, the image display device 1300 may transmit a message 1277 (hereinafter, referred to as “second message”), which requests for checking program information, to the mobile terminal 110 via the server.

Afterwards, as illustrated in FIG. 33C, the user may transmit a message 1278 (hereinafter, referred to as “third message”), which checks the program information, to the image display device 1300 via the server, in response to the second message 1273.

As illustrated in FIG. 33D, the image display device 1300 may then transmit a message 1279 (hereinafter, referred to as “fourth message”), which notifies that the program recording has been reserved, to the mobile terminal 1100 via the server.

The image display device 1300 may then transmit, to the mobile terminal 1100 via the server, a message 1280 (hereinafter, referred to as “fifth message”) indicating the start of the program recording, and a message 1281 (hereinafter, referred to as “sixth message”) indicating the completion of the program recording.

Also, the image display device 1300 may transmit a message 1282 (hereinafter, referred to as “seventh message”) including an advertisement content, to the mobile terminal 1100 via the server. The image display device 1300 may analyze user information related to the paired mobile terminal 1100, select an advertisement content based on use pattern information of the user, and transmit the seventh message 1282 including the selected advertisement content to the mobile terminal 1100.

As illustrated, the controller 180 may allow the user to select whether to display the advertisement content included in the seventh message 1282 in detail either on the image display device 1300 or on the mobile terminal 1100. Afterwards, although not illustrated, at least one of the image display device 1300 and the mobile terminal 1100 may display the advertisement content in detail based on the user's selection.

On the other hand, although not illustrated, the image display device 1300 may read out internal information related to a content using metadata, based on a control command included in a message received from the mobile terminal 1100. That is, the image display device 1300 may output a part of content in such a manner of databasing the content itself.

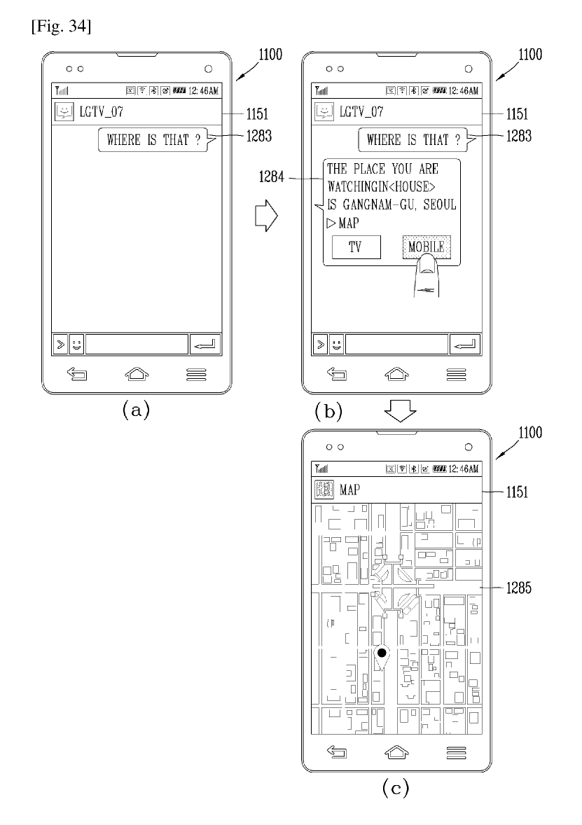

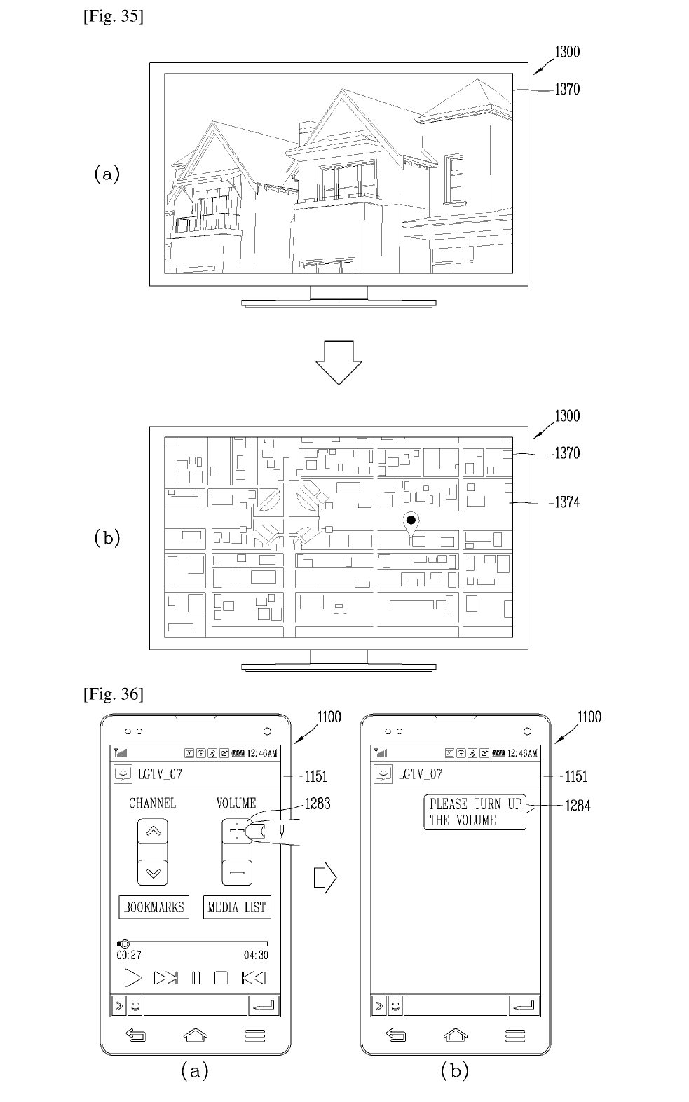

As illustrated in FIGS. 34 and 35, information received from the image display device 1300 may be cooperative (interwork) with an application stored in the mobile terminal 1100.

In detail, as illustrated in FIG. 34A, the user may transmit, to the image display device 1300 via the server, a message 1283 (hereinafter, referred to as “first message”), which requests for information (position information) related to a content, which is currently output on the image display device 1300, using a virtual keypad while an execution screen of a messenger application is displayed.

Next, as illustrated in FIG. 34B, the image display device 1300 may transmit a message 1284 (hereinafter, referred to as “second message”), which includes the position information, to the mobile terminal 1100 via the server.

As illustrated, the controller 180 may allow the user to select whether to display a map content, which corresponds to the position information included in the second message 1284, either on the image display device 1300 or on the mobile terminal 1100.

Here, when the user selects the mobile terminal 1100 to display the map content, as illustrated in FIG. 34C, the mobile terminal 1100 may display the map content 1285, which corresponds to the position information included in the second message 1284, on the display unit 1151.

On the other hand, when the user selects the image display device 1300 to display the map content, as illustrated in FIGS. 35A and 35B, the image display device 1300 may stop the output of a current-displayed content, and start to output the map content 1274 on the display unit 1370.

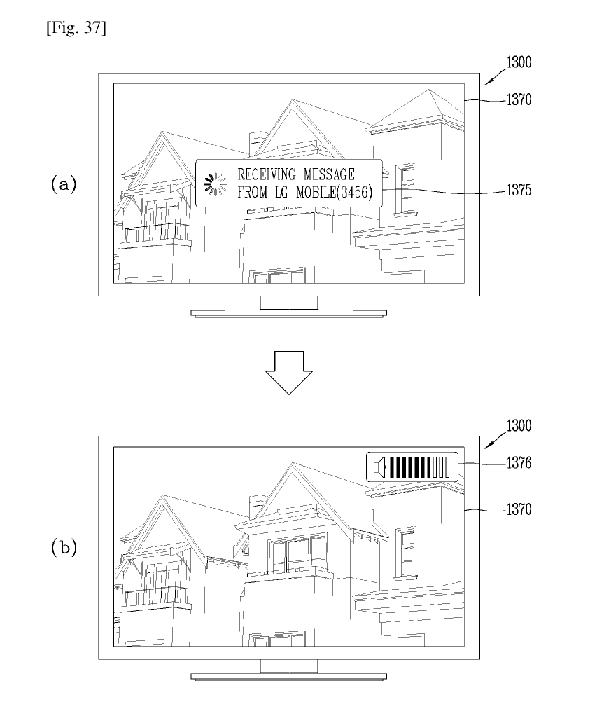

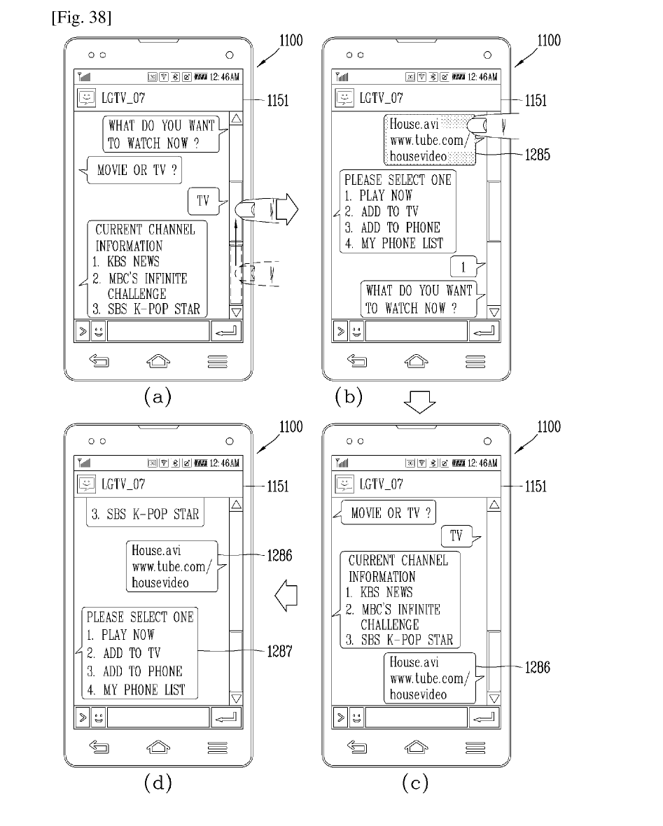

As illustrated in FIGS. 36 and 37, the mobile terminal 1100 may transmit a message including a control command for controlling the image display device 1300 to the image display device 1300.

In detail, as illustrated in FIG. 36A, the display unit 1151 of the mobile terminal 1100 may output at least one virtual button 1283 for controlling the function of the image display device 1300.

Here, when one (for example, a virtual button corresponding to a function of turning up the volume) of the virtual buttons 1283 is selected, as illustrated in FIG. 36B, the mobile terminal 1100 may transmit a message including a volume adjustment control command to the image display device 1300 via the server to turn up the volume of the image display device 1300. Accordingly, a message 1284 including the volume adjustment control command may be displayed on the execution screen of the messenger application.

As illustrated in FIG. 37A, on the other hand, the image display device 1300 may receive the message including the volume adjustment control command from the mobile terminal 1100 via the server. The display unit 1370 of the image display device 1300 may output a popup window 1373 indicating that the message is under reception from the mobile terminal 1100.

Afterwards, as illustrated in FIG. 37B, the image display device 1300 may adjust the volume based on the received message. Accordingly, a popup window 1376 indicating that the volume has been adjusted may be output on the display unit 1370 of the image display device 1300.

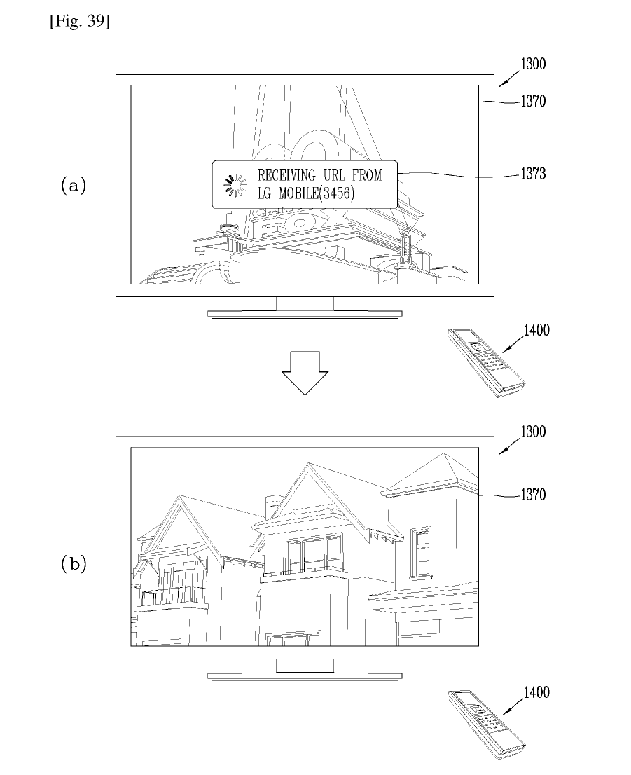

As illustrated in FIGS. 38 and 39, the mobile terminal 1100 may retransmit a message selected from pre-transmitted messages to the image display device 1300.

As illustrated in FIGS. 38A and 38B, the display unit 1151 of the mobile terminal 1100 may display a plurality of pre-transmitted messages. The controller 180 may scroll the pre-transmitted messages, displayed on the display unit 1151, based on a touch input (for example, a flicking input) sensed on the display unit 1151.

Here, when one message 1285 (for example, a message including a URL corresponding to a content) is selected from the pre-transmitted messages, as illustrated in FIG. 38C, the controller 180 may transmit a message 1286 (hereinafter, referred to as “second message”), which includes the same text as the first message 1285, to the image display device 1300.

That is, the controller 180 may transmit the URL corresponding to the content to the paired image display device 1300, together with the control command indicating that the content is output directly to the image display device 1300. Accordingly, the second message 1286 including the URL information corresponding to the content may be displayed on the execution screen of the messenger application.

As illustrated in FIG. 38D, the controller 180 may receive a message 1287 (hereinafter, referred to as “third message”), which includes selection items for allowing the user to select whether or not to play back the content, from the image display device 1300 via the server.

On the other hand, as illustrated in FIG. 39A, the image display device 1300 may receive, from the paired mobile terminal 1100, a control command to output the URL and the content directly to the image display device 1300. The display unit 1370 of the image display device 1300 may output a popup window 1373 indicating that the URL is under reception from the mobile terminal 1100.

Afterwards, as illustrated in FIG. 39B, the image display device 1300 may access the server to search for the content corresponding to the URL. The display unit 1370 of the image display device 1300 may stop the output of a currently-output content, and start to output the searched content.

Further, in accordance with one embodiment of the present disclosure, the method can be implemented as processor-readable codes in a program-recorded medium. Examples of such processor-readable media may include ROM, RAM, CD-ROM, magnetic tape, floppy disk, optical data storage element and the like. Also, the processor-readable medium may also be implemented as a format of carrier wave (e.g., transmission via an Internet).

The configuration and method of the aforementioned embodiments may not be applied to the mobile terminal in a limiting manner, but those embodiments may be configured by selective combination of all or part of each embodiment so as to implement different variations.

1. A mobile terminal comprising:
a wireless communication unit that is configured to perform bidirectional communication with an image display device and perform pairing with the image display device;
a display unit that is configured to display a content thereon; and
a controller that is configured to execute an application in response to a preset touch input being sensed on the content, and transmit a uniform resource locator (URL) corresponding to the content to the image display device, such that the content can be output on the image display device, when a preset icon is selected from icons displayed on an execution screen of the application.

2. The terminal of claim 1, wherein the controller displays a list of image display devices including items when the application is executed, the items corresponding to a plurality of image display devices, respectively, located in the same network as the mobile terminal, and wherein the wireless communication unit performs pairing with an image display device corresponding to at least one item selected, when the at least one item is selected from the items corresponding to the plurality of image display devices.

3. The terminal of claim 2, wherein the controller displays a popup window for receiving an authentication code, entered in relation to the image display device, and
wherein the controller performs pairing with the image display device when the authentication code related to the image display device is entered through the popup window.

4. The terminal of claim 3, wherein the controller displays information related to the paired image display device on the execution screen of the application.

5. The terminal of claim 1, wherein the controller displays a list of applications including items corresponding to a plurality of applications, respectively, related to the content, when a preset touch input is sensed on the content, and
wherein the controller executes an application corresponding to an item selected from the list of applications.

6. The terminal of claim 5, wherein the list of applications comprises an item of the application corresponding to a function of outputting the content to the image display device.

7. The terminal of claim 5, wherein the controller displays information related to the content on the execution screen of the application.

8. The terminal of claim 7, wherein the information related to the content comprises at least one of a name, a capacity and a file attribute of the content.

9. The terminal of claim 5, wherein the execution screen of the application comprises a first icon corresponding to a function of outputting the content directly to the image display device, and wherein the controller transmits a URL corresponding to the content to the image display device, together with a control command to output the content directly to the image display device when the first icon is selected.

10. The terminal of claim 5, wherein the execution screen of the application comprises a second icon corresponding to a function of adding the content to a reproduction list of the image display device, and
wherein the controller transmits the URL corresponding to the content to the image display device, together with a control command to output the content to the image display device after stopping an output of a currently-output another content, when the second icon is selected.

11. The terminal of claim 5, wherein the execution screen of the application comprises a third icon corresponding to a function of adding the content to a reproduction list of the mobile terminal, and wherein the controller adds the content to the reproduction list of the mobile terminal when the third icon is selected.

12. The terminal of claim 5, wherein the execution screen of the application comprises a fourth icon corresponding to a function of displaying a reproduction list of the mobile terminal, including the content, and
wherein the controller displays the reproduction list including items corresponding to pre-added contents when the fourth icon is selected.

13. The terminal of claim 12, wherein the controller edits the reproduction list based on a touch input sensed on the reproduction list.

14. The terminal of claim 12, wherein the controller transmits a URL of a content, corresponding to an item selected from the reproduction list, to the image display device.

15. A mobile terminal comprising:
a wireless communication unit that is configured to perform bidirectional communication with an image display device, perform pairing with the image display device, and receive a message from the image display device via a server;
a display unit that is configured to be touch-sensitive for allowing an input of a message to be transmitted to the image display device, and display both the received message and the input message; and
a controller that is configured to transmit the input message to the image display device via the server such that the image display device can be controlled according to a control command included in the input message.

16. The terminal of claim 15, wherein the controller displays a popup window for allowing entering of an authentication code, in relation to the image display device, and
wherein the controller transmits a message including an entered authentication code to the image display device via the server when the authentication code related to the image display device is entered through the pop-up window.

17. The terminal of claim 16, wherein the controller displays the received message on an execution screen of a messenger application while a messenger application is executed on a foreground.

18. The terminal of claim 17, wherein the controller receives a message, which is input in response to the received message, on the execution screen of the messenger application, and transmits the input message to the image display device via the server.

19. The terminal of claim 18, wherein the controller transmits a message including a uniform resource locator (URL) corresponding to a content to the image display device via the server, such that the image display device can be controlled in relation to the content.

20. The terminal of claim 19, wherein the controller displays a list of applications including items when a preset touch input is sensed on the content while the content is displayed, the items corresponding to a plurality of applications, respectively, related to the content, and wherein the controller transmits a message including the URL corresponding to the content to the image display device via the server when a preset item is selected from the list of applications.

21. The terminal of claim 16, wherein the display unit outputs at least one virtual button for controlling a function of the image display device, and
wherein the controller transmits a message including a control command, corresponding to a touched virtual button, to the image display device via the server, such that the image display device can be controlled according to the control command corresponding to the touched virtual button when a touch input is sensed on the virtual button.

22. The terminal of claim 18, wherein the display unit displays a plurality of pre-transmitted messages, and
wherein the controller retransmits a selected one message to the image display device via the server when the one message is selected from the pre-transmitted messages.
